(19) United States
(12) Patent Application Publication
(10) Pub. No.: US 2026/0329649 A1
(43) Pub. Date: Oct. 22, 2026

(54) SYSTEM

(71) Applicant: SoftBank Group Corp., Tokyo (JP)

(72) Inventor: Kensuke FUKUSHIMA, Tokyo (JP)

(73) Assignee: SoftBank Group Corp., Tokyo (JP)

(21) Appl. No.: 19/649,148

(22) Filed: Apr. 16, 2026

(30) Foreign Application Priority Data
Apr. 22, 2025 (JP) 2025-070935

(51) Int. Cl. G06F 9/50; G06N 20/00

(52) U.S. Cl. CPC G06F 9/5027; G06N 20/00

(57) ABSTRACT

The present invention relates to a communication infrastructure optimization system comprising: a communication platform installed in a stratosphere; a sensor data collection unit configured to collect various sensor data such as weather, communication traffic, and device states; and an analysis unit and a control unit configured to integrally analyze these data using a generative AI and autonomously and dynamically optimize frequency allocation, power distribution, and communication area arrangement, wherein the system flexibly responds to communication demand and weather fluctuation in real time and realizes a high communication continuation rate and operation cost reduction in areas and situations where communication infrastructure development is difficult, such as mountainous areas, remote islands, emerging countries, and disaster sites.

### CROSS-REFERENCE TO RELATED APPLICATION

The present application claims priority to and incorporates by reference the entire contents of Japanese Patent Application No. 2025-070935 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is a social problem that in areas where the development of conventional terrestrial communication infrastructure is difficult, such as mountainous areas, remote islands, and emerging countries, communication connectivity is significantly lacking, and the spread of basic communication services such as the Internet and voice communication is hindered; an emergency response problem that when a terrestrial network is disrupted in the event of a disaster, rescue operations and information sharing are significantly delayed, causing a serious hindrance to the protection of life and property; an operational problem that in a situation where communication demand fluctuates rapidly, such as when an event is held or a disaster occurs, a statically designed conventional network cannot flexibly respond, leading to a deterioration in communication quality and an increase in operation costs; a technical problem that it is difficult for a conventional system to perform real-time adaptation and autonomous restoration in response to weather fluctuations and device abnormalities in a special environment of the stratosphere, and a communication continuation rate and service reliability cannot be maintained at a high level; and an economic and social problem that in the construction of a smart city or an IoT platform, dynamic network optimization and efficient resource allocation cannot be realized, which is an inhibiting factor for the spread of the Internet and the creation of new services in emerging markets.

### SUMMARY OF THE INVENTION

A means for solving the problem according to the present invention is to configure a system comprising: a communication platform installed in a stratosphere; a sensor data collection unit mounted on the communication platform; an analysis unit using a generative AI configured to integrally analyze weather data, communication traffic data, and device state data acquired from the sensor data collection unit; and a control unit configured to autonomously optimize frequency allocation, power distribution, and communication area arrangement based on an analysis result of the analysis unit. Specifically, the sensor data collection unit acquires, in real time, weather information such as temperature, wind speed, humidity, and presence or absence of a storm in a stratospheric environment, and device information such as a remaining battery level and a failure state of a communication device; the analysis unit accumulates past weather data and communication traffic patterns as a long-term memory, processes a vast amount of sensor data in real time using the generative AI, and performs prediction of communication demand, prediction of weather fluctuation, and detection of device abnormality; and the control unit automatically executes frequency interference avoidance, optimization of power distribution, and dynamic adjustment of a communication area radius based on the analysis result, takes a communication restoration measure immediately in the event of a disaster to ensure a high communication continuation rate, and further realizes operation cost reduction and communication infrastructure development in an emerging market or in the event of a disaster.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

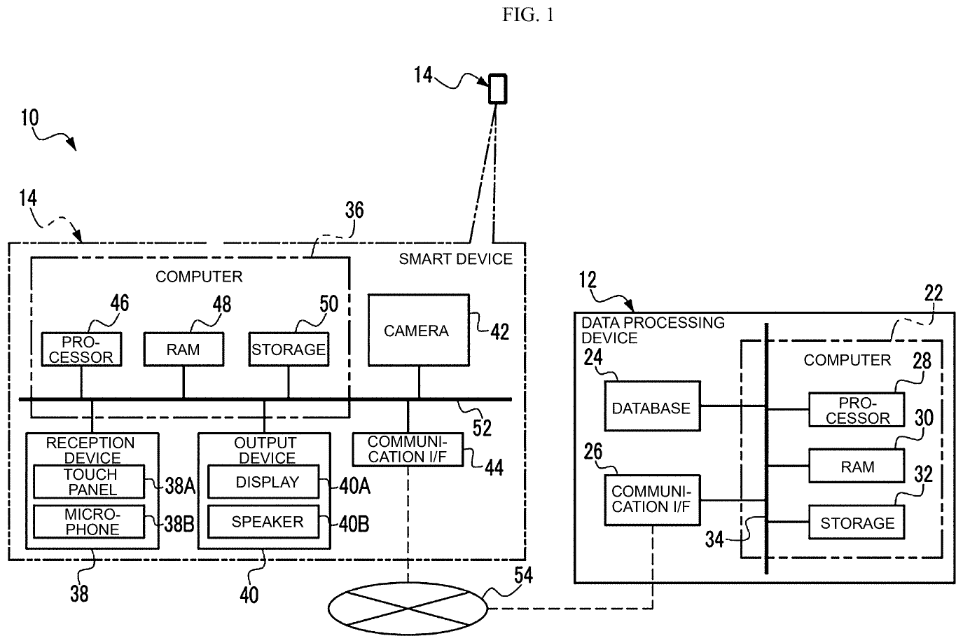

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

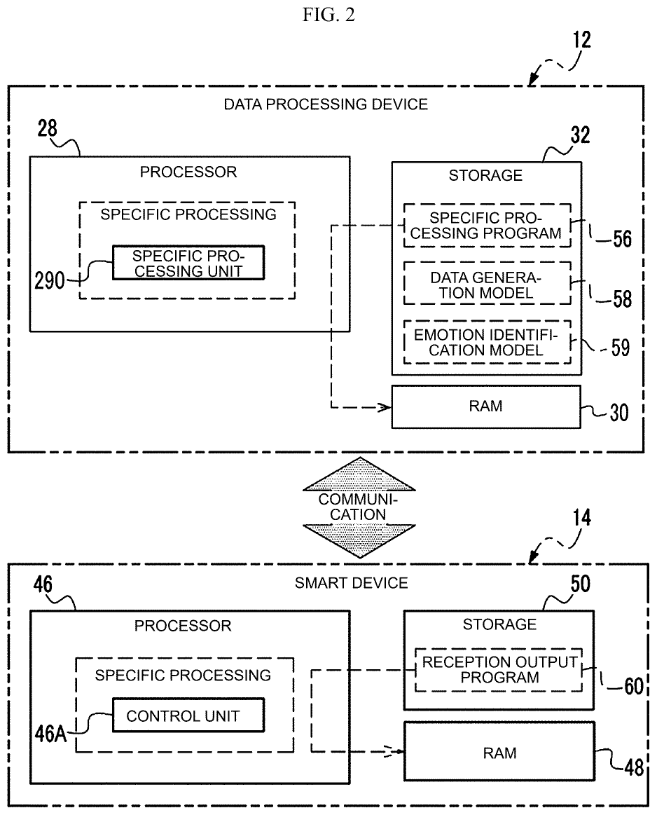

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The present invention is a system composed of a communication platform installed in a stratosphere, a server, a terminal, and a network infrastructure linking them, and will be described in depth from all perspectives, such as functional division of each component, a utilization method of a generative AI, a specific operation scenario, a response in the event of a failure, various optimization processes, a data flow, and system expandability. Specifically, the present system includes a parallel computing cluster consisting of a plurality of computing nodes having advanced computing capability. The present system establishes a low-latency and broadband data link between the stratospheric communication platform and a ground server. The present system implements a complex neural network architecture including a large language model and a time-series prediction model. The present system executes a non-linear operation in a high-dimensional tensor space. Unlike conventional static rule-based network management, the present system autonomously adapts to dynamic environmental changes. The present system brings about technical effects of reducing communication delay and improving a packet loss rate. The present system is useful in specific application fields such as an emergency communication infrastructure in the event of a disaster and a backbone communication network of a smart city. The present system integrally processes a vast amount of data collected from each component. The present system executes data-driven decision making in real time. The present system maximizes utilization efficiency of hardware resources. The present system maintains system availability while minimizing human intervention. The present system provides a foundation for a next-generation communication infrastructure through these technical improvements.

First, the stratospheric communication platform is equipped with a weather sensor (temperature, atmospheric pressure, humidity, wind speed, wind direction, precipitation, solar radiation, lightning detection, ultraviolet amount, ozone concentration measurement sensor peculiar to the stratosphere, etc.), a communication traffic sensor (the number of communication packets, communication band usage, the number of terminal connections, communication delay, a packet loss rate, communication error occurrence frequency, communication volume for each terminal type, a peak band utilization rate, etc.), and a device state sensor (a remaining battery level, a power generation amount, power consumption, a device temperature, a cooling fan rotation speed, hardware abnormality detection, software error detection, a memory usage rate, a remaining storage capacity, an operation status of a communication module, etc.). These sensor data are acquired in real time on the terminal side and transmitted to the server at regular intervals (for example, every 10 seconds, every 1 minute, every 5 minutes, etc.). The transmission of the sensor data can also dynamically adjust the interval according to the communication band and the remaining battery level. Specifically, the present system converts an analog signal output from each sensor into digital data via an analog-to-digital converter. The present system expands the converted digital data on a memory as a multidimensional numerical vector. The present system formats weather data such as temperature and atmospheric pressure as a floating-point numerical array, for example. The present system structures communication traffic data as time-series tensor data. The present system encodes device state data as binary data including a status flag. The present system integrates these heterogeneous data and generates a single data frame to which a time stamp and position coordinates are added. The present system executes a noise removal filtering process on the generated data frame. The present system transmits the preprocessed data frame to the ground server. The present system continuously monitors a degree of tightness of the communication band. When the degree of tightness exceeds a predetermined threshold, the present system extends the transmission interval of the data frame. When the remaining battery level decreases, the present system applies a data compression algorithm to reduce a transmission data amount. The present system prevents depletion of communication resources by such dynamic transmission control. The present system exhibits a technical effect of maximizing data transmission efficiency within a limited band. The present system is applied to use cases such as wide-area environmental monitoring and remote infrastructure monitoring. The present system includes a local buffering mechanism for preventing data loss. The present system collectively transmits the data in the buffer when communication is restored. The present system thereby guarantees data integrity.

On the server side, a database unit configured to receive and accumulate a vast amount of sensor data, an analysis unit using a generative AI, a control unit configured to transmit a control command to the stratospheric communication platform and the terminal based on an analysis result, a monitoring unit configured to monitor an operation status of the entire system, a recovery unit configured to manage a restoration measure in the event of a failure, and the like are provided. The generative AI is composed of a plurality of AI modules such as a large language model, a time-series prediction model, an abnormality detection model, a reinforcement learning model, and an optimization algorithm, for example. The generative AI retains weather data, communication traffic data, and device state data for the past several years as a long-term memory, and performs time-series analysis, clustering, pattern recognition, abnormality detection, prediction model generation, optimization calculation, and the like. Specifically, the present system stores the received data frame in a distributed relational database. The analysis unit implements a large language model based on a transformer architecture and a time-series prediction model including a long short-term memory network. The analysis unit receives, as input data, a one-dimensional numerical vector indicating a temperature transition for the past 24 hours, a time-series array indicating a packet loss rate for the past 1 hour, and a scalar value indicating a current battery temperature. The analysis unit normalizes these input data and generates an embedding vector for mapping to a common latent space. The analysis unit calculates a hidden correlation between respective input feature amounts using a self-attention mechanism. The analysis unit outputs, as output data, a probability distribution indicating a predicted value of communication traffic for the next 1 hour, an abnormality score from 0 to 1 indicating an occurrence probability of a device failure, and structured data indicating a recommended control parameter. When the output abnormality score exceeds 0.8, the control unit executes a restart sequence of the corresponding device. The present system continuously updates a weight parameter of each model using a gradient descent method. The present system uses a mean square error as a loss function to improve prediction accuracy. The present system executes non-linear pattern recognition in a high-dimensional space that does not depend on human intuition. The present system brings about technical effects of improving an operation rate of the entire system and reducing a failure occurrence rate. The present system is applicable to fields such as autonomous control of an unmanned aerial vehicle and automatic operation of a large-scale communication network. The present system performs data transfer between the respective modules via a high-speed message queue. The present system thereby minimizes a processing delay of the entire system.

For example, regarding the weather data, a past weather pattern in the same period is compared with current weather data to predict a weather fluctuation (for example, a rapid temperature drop, a strong wind, a storm, a thunderstorm, an atmospheric pressure fluctuation peculiar to the stratosphere, etc.) for the next few hours to few days. Regarding the communication traffic data, a communication traffic history at the time of holding a past event or occurrence of a disaster is collated with a current traffic situation to predict a rapid increase in future communication demand and a change in a communication pattern (for example, communication concentration in a specific time zone, communication volume fluctuation for each terminal type, mass connection of IoT devices, etc.). Regarding the device state data, a sign of a device failure or a sign of an abnormal operation is detected from a transition of a remaining battery level, a change in a device temperature, an occurrence frequency of a hardware abnormality, a tendency of a software error, and the like. Specifically, the analysis unit inputs a time-series tensor indicating an atmospheric pressure fluctuation for the past 30 days and a current wind speed vector to a weather prediction model. The analysis unit extracts a local feature map from the time-series data using a convolutional neural network. The analysis unit inputs the extracted feature map to a fully connected layer. The analysis unit outputs, as an output, a score from 0.0 to 1.0 indicating an occurrence probability of a rapid temperature drop within the next 6 hours, and numerical data of a predicted maximum wind speed. The analysis unit inputs a multidimensional array indicating a transition of the number of packets at the time of a past event and a scalar value of the current number of connected terminals to a communication traffic prediction model. The analysis unit learns a temporal dependency using a recurrent neural network. The analysis unit outputs, as an output, a predicted value of a peak band utilization rate in the next 1 hour, and a predicted distribution of the number of connection requests from IoT devices. The analysis unit inputs a time-series vector indicating a battery temperature transition for the past 24 hours and the number of occurrences of a memory error to an abnormality detection model. The analysis unit compresses the input data into a low-dimensional space using an autoencoder, and restores it to the original dimension again. The analysis unit calculates a reconstruction error between the input data and the restored data. The analysis unit outputs an abnormality degree score based on the reconstruction error as an output. When the abnormality degree score exceeds a predetermined threshold, the control unit executes a transition process to a preventive maintenance mode. The present system executes these prediction and detection processes at high speed on the parallel computing cluster. The present system realizes early discovery of a minute sign impossible for a human operator. The present system brings about technical effects of minimizing downtime and optimally arranging resources. The present system is applied to use cases such as an air traffic control system and predictive maintenance of a large-scale data center. The present system uses a prediction result as an initial value of a subsequent optimization algorithm. The present system thereby improves a convergence speed of optimization calculation.

The generative AI dynamically optimizes an operation parameter of the stratospheric communication platform based on these prediction and detection results. For example, when a weather fluctuation is severe, the AI instructs the control unit to reduce a communication area radius and maintain stable communication quality. When communication demand rapidly increases, the AI expands a frequency band and automatically determines optimal frequency allocation for avoiding interference. When a remaining battery level decreases, the AI reviews power distribution and instructs to preferentially supply power to a communication device having high importance. For example, in the event of a disaster, the AI immediately detects occurrence of the disaster from a plurality of sensor data, and simultaneously executes a plurality of restoration measures such as switching to a backup frequency band, reconfiguration of a communication area, activation of a standby power supply, redundancy of a communication path, and allocation of priority communication. Specifically, the analysis unit executes optimization of the operation parameter using a reinforcement learning algorithm. The analysis unit constructs an environment model based on a Markov decision process. The analysis unit defines a current weather prediction score, a traffic prediction distribution, and a device abnormality degree score as a state vector. The analysis unit defines a change amount of the communication area radius, a shift amount of an allocated frequency band, and a power supply ratio to each device as an action vector. The analysis unit sets a maintenance rate of communication quality and a reduction amount of power consumption as a reward function. The analysis unit approximates an optimal action value function using a Q-learning algorithm. The analysis unit receives a current state vector as an input. The analysis unit outputs, as an output, an optimal action vector that maximizes an expected reward. The control unit converts the output action vector into a specific hardware control command. The control unit physically reduces the communication area radius by changing a directivity parameter of an antenna, for example. The control unit dynamically expands the frequency band by rewriting a setting of a software defined radio module. The control unit transmits an instruction to change a duty ratio of a PWM signal to a power management IC, and adjusts the power distribution. When detecting the occurrence of a disaster, the present system immediately generates an interrupt process. The present system dynamically rewrites a routing table to make the communication path redundant. The present system executes these processes with a latency in milliseconds. The present system dramatically improves an adaptation speed of the system to an environmental change. The present system exhibits technical effects of preventing communication disconnection and ensuring service continuity. The present system is applicable to fields such as a military communication network and network control of an emergency vehicle. The present system records the executed action and the reward obtained as a result thereof in a database. The present system continuously relearns the reinforcement learning model using this record.

In addition, the generative AI cooperates not only with prediction of communication traffic but also with a weather simulation and a quantum-inspired optimization algorithm to solve a complex optimization problem at high speed. For example, when a plurality of stratospheric communication platforms are operated simultaneously, the AI comprehensively analyzes a position, a weather situation, communication demand, and a device state of each platform, and determines an optimal arrangement and resource distribution. Furthermore, when international frequency coordination is required, the AI automatically refers to regulatory information and a usage status of each country, and proposes frequency allocation that minimizes an interference risk. Specifically, the analysis unit communicates with a computing accelerator that executes a quantum-inspired optimization algorithm based on an Ising model. The analysis unit generates, as input data, three-dimensional coordinates of a plurality of platforms, polygon data indicating communication coverage of each platform, and a heat map tensor indicating predicted communication demand of each area. The analysis unit formulates these input data as an objective function and a constraint condition of a combinatorial optimization problem. The analysis unit converts the formulated problem into an interaction matrix of spin variables. The analysis unit searches for a spin array that minimizes an energy function using a simulated annealing method. The analysis unit outputs, as an output, a vector group indicating optimal movement target coordinates of each platform, and a list of frequency channels to be allocated to each platform. The control unit transmits the output target coordinate vector to a flight controller of each platform. In international frequency coordination, the analysis unit inputs a list of available frequency bands acquired from a radio law regulation database of each country and a matrix indicating an interference tolerance value with an adjacent country. The analysis unit models frequency allocation as a graph coloring problem. The analysis unit outputs, as an output, structured data indicating a frequency allocation pattern that minimizes an interference penalty score. The present system searches for an optimal solution from a vast amount of combinations in polynomial time. The present system brings about a technical effect of achieving overall optimization of a wide area network while suppressing consumption of computing resources. The present system is applied to use cases such as operation management of a low earth orbit satellite constellation and a global logistics tracking system. The present system stores a local optimal solution obtained in a process of optimization calculation in a cache memory. The present system reuses the cache to shorten a calculation time when a similar optimization problem occurs.

As a specific operation example, in a mountainous area, for example, when a weather sensor detects a rapid temperature drop or a strong wind, the AI reduces a communication area and suppresses power consumption of a device. In a remote island, the AI predicts that communication demand will rapidly increase during a tourist season or when an event is held, and expands a frequency band and power distribution in advance. In an urban area of an emerging market, the AI cooperates with traffic volume and population density data, and dynamically reconfigures an optimal communication area arrangement. In the event of a disaster, the AI immediately detects an abnormal value from a seismometer or a weather sensor, and automatically activates a backup mode of the communication platform. Specifically, in operation in a mountainous area, when wind speed data acquired from a weather sensor is input as a numerical vector exceeding 30 meters per second, the present system recalculates a beamforming weight matrix of an antenna. The present system applies the recalculated weight matrix to a phased array antenna, and physically narrows down a radiation pattern of a radio wave. The present system thereby reduces power consumption of a transmission amplifier. In operation in a remote island, the present system receives, as an input, time-series data indicating a transition of the number of tourists in the past and a natural language processing vector indicating a posting amount of SNS. The present system predicts peak communication traffic on the next day using a regression model. When a predicted value exceeds 80 percent of a current band capacity, the present system outputs a control signal for activating a standby transceiver module. In an urban area of an emerging market, the present system inputs an image recognition tensor indicating the number of vehicles on a road and a GPS coordinate group of a mobile terminal. The present system calculates barycentric coordinates of a densely populated area using a clustering algorithm. The present system outputs a thrust control command for moving the communication platform toward the calculated barycentric coordinates. In the event of a disaster, the present system detects that an acceleration tensor acquired from a seismometer exceeds a predetermined threshold. The present system immediately executes a failover process from a main system to a standby system. The present system autonomously executes these processes without human intervention. The present system exhibits a technical effect of improving a response speed of the system to a local change in an environment. The present system is applicable to fields such as temporary network construction at an event venue and emergency communication securing in a disaster area. The present system stores a transition of a control parameter in each operation scenario as a log. The present system utilizes this log as learning data for future model improvement.

Furthermore, when operating as a smart city or an IoT foundation, the AI also cooperates with sensor data of an urban infrastructure (for example, a traffic sensor, an environmental sensor, a disaster prevention sensor, etc.), comprehensively evaluates communication demand and a disaster risk of the entire city, and maintains an optimal network configuration in real time. For example, when a large-scale event is held, the AI analyzes human flow data and posting data of SNS, predicts a peak of communication demand in advance, and pre-allocates resources. When a large number of IoT devices are connected, the AI learns a communication pattern for each device, and realizes efficient band allocation and priority control. Specifically, the analysis unit implements a multimodal neural network for integrating heterogeneous data collected from each sensor of the urban infrastructure. The analysis unit receives, as input data, a one-dimensional tensor indicating the number of vehicles extracted from a camera image of an intersection, a scalar value indicating a PM2.5 concentration from an air pollution measuring instrument, and a time-series array indicating a water level fluctuation from a river water level gauge. The analysis unit applies a dedicated encoder network to each input modality, and extracts a common latent feature vector. The analysis unit combines the extracted feature vectors, and outputs a communication demand heat map and a disaster risk score of the entire city via a fully connected layer. At the time of a large-scale event, the analysis unit inputs a human flow density matrix generated from a position information log of a smartphone and an emotion polarity vector extracted from an SNS text. The analysis unit predicts a rapid increase timing of communication demand in a specific area using an attention mechanism. The analysis unit outputs, as an output, an integer array indicating the number of resource blocks to be allocated to each base station. The control unit updates a scheduler of a MAC layer based on this integer array. At the time of connection of an IoT device, the analysis unit inputs a feature vector indicating a packet transmission interval and a payload size of each device. The analysis unit classifies devices into a plurality of traffic profiles using a K-means method which is unsupervised learning. The analysis unit outputs, as an output, a cluster ID to which each device belongs. The control unit dynamically sets a QoS parameter based on the cluster ID. The present system processes a vast data stream on a city scale in real time. The present system brings about technical effects of preventing network congestion and maximizing throughput. The present system is applied to use cases such as a control network of an autonomous driving vehicle and a communication foundation of a smart grid. The present system performs initial data filtering on an edge device side. The present system thereby reduces a communication load on a central server.

In addition, the generative AI is actively utilized for a restoration measure in the event of a failure. For example, when a part of devices of the communication platform fails, the AI automatically selects a redundant communication path and ensures continuation of a communication service. When a remaining battery level rapidly decreases, the AI temporarily stops a device with high power consumption and maintains only an important communication function. In the event of a disaster, the AI can preferentially allocate a band to communication with high priority (for example, rescue activities and transmission of disaster prevention information), and temporarily restrict communication of general users. Specifically, the analysis unit includes a hybrid architecture combining an expert system for failure restoration and a reinforcement learning agent. The analysis unit receives, as input data, a numerical vector indicating a response delay time of an alive monitoring packet of each hardware component, and an embedding representation obtained by vectorizing text data of an error log. The analysis unit specifies a failure location using a support vector machine. The analysis unit outputs, as an output, an identifier of a failed module and a routing table of a recommended alternative path. The control unit writes the output routing table into a forwarding information base of a network switch. The present system receives, as an input, a scalar value indicating that a battery voltage has fallen below a specified value. The analysis unit evaluates a matrix indicating a power consumption profile of each device and a current task importance. The analysis unit outputs, as an output, a binary vector indicating a list of devices whose power supply should be cut off. The control unit controls a solid state relay based on this binary vector, and physically cuts off power supply. When a disaster occurrence flag is turned on, the present system analyzes a DSCP value of a packet header. The present system allocates a queue with the highest priority to a packet from a specific IP address group related to rescue activities. The present system applies band restriction to traffic of general users using a token bucket algorithm. The present system avoids a fatal stop of the system without waiting for human intervention by these autonomous failure response processes. The present system exhibits a technical effect of dramatically improving system availability and fault tolerance in a mission-critical environment. The present system is applicable to fields such as a telemedicine network and a monitoring system of an important infrastructure. The present system executes a self-diagnosis test after completion of a restoration process. The present system re-evaluates soundness of the system based on a test result.

Regarding system expandability, the generative AI can flexibly respond to addition of a new sensor or an external data source. For example, when a new weather sensor or IoT device is introduced in the future, the AI automatically learns additional data and improves prediction accuracy and optimization performance. Furthermore, the AI can continuously learn performance data obtained during operation, and update an optimization algorithm in a self-evolving manner. Specifically, the analysis unit implements mechanisms of transfer learning and online learning. The present system detects an unknown data format transmitted from a newly connected sensor device. The present system analyzes a data schema definition file, and dynamically generates a parser module for parsing new data. The analysis unit receives, as input data from a new sensor, a floating-point array indicating an unknown gas concentration, for example. The analysis unit dynamically adds a new node to an input layer of an existing neural network. The analysis unit transfers an initial weight of the added node from a pre-trained model. The analysis unit executes fine tuning of the network using an expanded feature vector including the new data. The analysis unit outputs, as an output, an updated prediction score taking the new data into consideration. The present system continuously calculates a residual vector indicating an error between a predicted value collected during operation and an actual observation value. The present system accumulates this residual vector as teacher data. The present system periodically updates a weight parameter of the model by backpropagation using the accumulated data batch. The present system automatically adjusts a learning rate and a batch size using a hyperparameter optimization algorithm. The present system improves inference accuracy of the model while remaining in an operating state without accompanying software redeployment. The present system brings about technical effects of preventing system obsolescence and reducing a long-term operation cost. The present system is applied to use cases such as a space probe requiring continuous function expansion and a testbed of a next-generation communication standard. The present system performs performance evaluation in a shadow test environment before updating the model. The present system replaces the model in a production environment only when performance improvement is confirmed.

As described above, in the embodiment of the present invention, the generative AI mainly operates on the server side, and some functions are also distributed to the terminal side, whereby a vast amount of and various sensor data can be analyzed in real time, and optimal operation of the communication infrastructure can be autonomously and dynamically realized. The utilization of the generative AI is the core of the present invention, and brings flexibility, responsiveness, efficiency, scalability, and fault tolerance that were impossible with conventional static network design. Specifically, the present system adopts an edge computing architecture and dynamically distributes a calculation load between the server and the terminal. The present system deploys a lightweight neural network model dedicated to inference on the terminal side. The present terminal receives, as input data, a time-series tensor indicating high-frequency vibration data acquired from a built-in sensor. The present terminal compresses weights of the model into 8-bit integers using a quantization technique, and executes inference with limited computational resources. The present terminal outputs, as an output, a binary flag indicating the presence or absence of an abnormality and a feature amount vector. The present terminal transmits the feature amount vector to the server only when the abnormality flag is true. The present server executes detailed cause analysis using a larger-scale deep learning model with the received feature amount vector as an input. The present server outputs, as an output, a classification label indicating a specific failure mode. The present system constructs such a hierarchical data processing pipeline. The present system reduces response delay of the entire system while minimizing consumption of a network band. The present system adapts to a non-linear and complex environmental change that cannot be handled by conventional rule-based static threshold determination. The present system exhibits technical effects of reducing a data transfer amount and reducing a calculation load on the cloud side. The present system is extremely useful in specific application fields such as a V2X communication network to which a large number of autonomous driving vehicles are connected and a cooperative control system of industrial robots distributed over a wide area. The present system periodically updates the model on the terminal side from the server side via wireless communication. The present system thereby keeps edge intelligence of the entire system always up to date.

### System Configuration

The system according to the present embodiment includes a sensor data collection unit, a data transmission unit, a database unit, a generative AI analysis unit, an optimization control unit, a monitoring unit, a recovery unit, and a user interface unit. The sensor data collection unit has a function of acquiring data from various sensors mounted on the stratospheric communication platform, and includes, for example, a weather sensor for temperature, atmospheric pressure, humidity, wind speed, wind direction, precipitation, solar radiation, lightning detection, ultraviolet amount, ozone concentration, and the like, a communication traffic sensor for the number of communication packets, communication band usage, the number of terminal connections, communication delay, a packet loss rate, communication error occurrence frequency, a communication amount for each terminal type, a peak band utilization rate, and the like, and a device state sensor for a remaining battery level, a power generation amount, power consumption, a device temperature, a cooling fan rotation speed, hardware abnormality detection, software error detection, a memory usage rate, a remaining storage amount, an operation status of a communication module, and the like. For example, when the stratospheric communication platform is arranged over a mountainous area, the data is acquired in real time when the temperature drops rapidly, and the data is immediately acquired even when the number of terminal connections rapidly increases during a tourist season over a remote island. Furthermore, even when the remaining battery level decreases or an abnormality occurs in the communication module, such information is collected without omission. Specifically, the present sensor data collection unit includes a microcontroller connected to each physical sensor via a serial communication bus. The present collection unit samples an analog voltage value output from each sensor into a digital value using a built-in AD converter. The present collection unit formats the sampled data as a fixed-length data packet including a sensor ID, a time stamp, and a measurement value. The present collection unit writes, for example, the temperature data as a floating-point number indicating Celsius and the number of communication packets as a 32-bit unsigned integer into a memory buffer. When the temperature drops rapidly in a mountainous area, the present collection unit calculates a differential value of an input value from the temperature sensor. When the differential value exceeds a predetermined threshold, the present collection unit generates a hardware interrupt and immediately generates a data packet. When the number of terminal connections rapidly increases over a remote island, the present collection unit monitors a hash table of MAC addresses and counts the number of unique connections. The present collection unit calculates a moving average of the count value and detects a rapid increase trend. The present collection unit monitors a cell voltage of a battery and estimates a remaining amount by polynomial approximation of a voltage drop curve. The present collection unit periodically polls an error register of the communication module and acquires the number of occurrences of a parity error and a CRC error. The present system implements a ring buffer structure on a memory for collecting these various data without loss. The present system optimizes a trade-off between a CPU load and data resolution by dynamically changing a data sampling rate. The present system brings about a technical effect of stably supplying a highly accurate input feature amount required in subsequent analysis processing. The present system is applied to use cases such as an environmental observation system under an extreme environment and payload management of a high-altitude pseudo-satellite. The present system locally performs an exclusion process of an abnormal value on the collected data. The present system thereby prevents mixing of noise.

The data transmission unit has a function of stably and efficiently transmitting the vast amount of data acquired by the sensor data collection unit from the stratospheric communication platform to the server on the ground. For example, when a communication band is tight, data compression and adjustment of a transmission interval are performed, and when a network is unstable such as in the event of a disaster, a redundant path is automatically selected to prevent data loss. Furthermore, highly important data (for example, a device abnormality, a sudden weather change, etc.) is preferentially transmitted, and batch transmission is performed in normal times, thereby realizing flexible transmission control according to the situation. Specifically, the present data transmission unit includes a network interface controller configured to generate a network frame having the collected data packet as a payload. The present transmission unit receives, as an input, a scalar value indicating a currently available uplink bandwidth. When the bandwidth falls below a predetermined threshold, the present transmission unit applies a lossless compression algorithm to the payload. The present transmission unit calculates a size of the compressed data frame and dynamically extends a scheduling interval of a transmission queue. The present transmission unit continuously monitors a metrics vector indicating a packet loss rate and a delay time of the network. When determining that the network is unstable, the present transmission unit recalculates a routing table of a redundant path via an alternative ground station using a dynamic routing protocol. The present transmission unit reads a priority flag added to a header of each data packet. The present transmission unit immediately moves a packet in which a hardware interrupt flag indicating a device abnormality or an alert flag indicating a sudden weather change is set to the head of a transmission buffer using an absolute priority queuing method. The present transmission unit accumulates periodic status log data having a low priority in a local storage until a certain data size is reached, and collectively transmits the data as batch processing. The present system executes such traffic shaping and QoS control at a hardware level. The present system exhibits a technical effect of maximizing utilization of limited wireless communication resources and minimizing arrival delay of critical data. The present system is applicable to fields such as a communication link between a deep space probe and an earth station, and a remote monitoring network of an offshore platform. The present system applies an automatic repeat request protocol to a packet that has failed to be transmitted. The present system thereby ensures end-to-end data reachability.

The database unit has a function of accumulating and managing, in chronological order, all sensor data received from the data transmission unit, past weather data, communication traffic data, device state data, urban infrastructure data and demographic data acquired from the outside, and the like. For example, weather data for the past several years is retained to analyze a weather pattern for each season, a communication traffic history at the time of holding an event is saved and utilized for demand prediction, and a failure history for each device is accumulated to be useful for improving accuracy of abnormality detection. Furthermore, data from an external disaster prevention sensor and traffic sensor is also integrally managed to cope with grasping of a situation of the entire city and smart city operation. Specifically, the present database unit includes a cluster of a distributed database and a time-series database capable of reading and writing petabyte-class data at high speed. The present database unit extracts a time stamp from the received data frame, and indexes the data using this as a primary key. The present database unit stores the weather data as a multidimensional floating-point tensor in a column-oriented storage. The present database unit downsamples the communication traffic data for each time resolution and saves it as a hierarchical data structure. The present database unit records the failure history of the device as a combination of text data and an error code in a document-oriented database. The present database unit parses the urban infrastructure data and the demographic data acquired from an external API endpoint. The present database unit maps the parsed data to an internal common schema, adds a spatial index, and stores the data in a geospatial database. The present database unit executes a distributed query engine for combining such heterogeneous data. In a learning phase of a machine learning model, the present database unit extracts a data set matching a designated period and condition at high speed. The present database unit converts the extracted data into a tensor format and directly supplies it to a learning pipeline. The present system automatically performs data sharding and replication to eliminate a single point of failure. The present system brings about a technical effect of shortening a response time of a search query for a vast amount of history data to the order of milliseconds. The present system is applied to use cases such as a national-scale weather information platform and a large-scale supply chain management system. The present system includes a lifecycle management function of automatically migrating old data to a cold storage. The present system thereby optimizes a storage cost.

The generative AI analysis unit has a core function of performing prediction of weather fluctuation, prediction of communication demand, detection of device abnormality, optimization calculation, and the like using the vast amount of data accumulated in the database unit. For example, past weather data and current weather data are compared to predict a weather fluctuation (a rapid temperature drop, a strong wind, a storm, a thunderstorm, an atmospheric pressure fluctuation peculiar to the stratosphere, etc.) for the next few hours to few days with high accuracy. Regarding the communication traffic data, a communication traffic history at the time of holding a past event or occurrence of a disaster is collated with a current traffic situation to predict a rapid increase in future communication demand and a change in a communication pattern (communication concentration in a specific time zone, a communication amount fluctuation for each terminal type, mass connection of IoT devices, etc.). Regarding the device state data, a sign of a device failure or a sign of an abnormal operation is detected from a transition of a remaining battery level, a change in a device temperature, an occurrence frequency of a hardware abnormality, a tendency of a software error, and the like. Furthermore, when a plurality of stratospheric communication platforms are operated simultaneously, the AI integrally analyzes a position, a weather situation, communication demand, and a device state of each platform, and determines optimal arrangement and resource allocation. The generative AI analysis unit also cooperates with a weather simulation and a quantum-inspired optimization algorithm to solve a complex optimization problem at high speed. For example, when international frequency coordination is required, the AI automatically refers to regulatory information and a utilization status of each country, and proposes frequency allocation that minimizes an interference risk. Specifically, the present analysis unit implements a deep learning framework operating on a parallel calculation cluster including a plurality of calculation accelerators. For prediction of weather fluctuation, the present analysis unit receives, as input data, a three-dimensional tensor indicating a spatial distribution of atmospheric pressure, temperature, and wind speed for the past 72 hours. The present analysis unit extracts spatial and temporal features using a three-dimensional convolutional neural network. The present analysis unit outputs, as an output, a prediction tensor indicating a precipitation probability and a maximum wind speed in each grid for the next 24 hours. For prediction of communication demand, the present analysis unit inputs a time-series vector indicating a past traffic history and a scalar value of the current number of connected terminals. The present analysis unit learns a traffic spike caused by a specific event using a self-attention mechanism of a transformer model. The present analysis unit outputs, as an output, a prediction distribution of a band utilization rate in the next one hour. For detection of device abnormality, the present analysis unit inputs a one-dimensional array indicating a transition of a battery voltage and a natural language embedding vector of an error log. The present analysis unit learns a data distribution in a normal state using a variational autoencoder, and outputs an abnormality score indicating how much the input data deviates from the distribution. In order to determine optimal arrangement of a plurality of platforms, the present analysis unit inputs current coordinates of each platform, a predicted communication demand heat map, and a weather prediction tensor. The present analysis unit searches for a ground state of an Ising model whose objective functions are maximization of communication coverage and minimization of interference using a quantum-inspired optimization algorithm. The present analysis unit outputs, as an output, a vector group indicating optimal destination coordinates of each platform. In international frequency coordination, the present analysis unit inputs a list of available frequency bands acquired from a radio law regulation database of each country. The present analysis unit models an interference risk between adjacent areas using a graph neural network. The present analysis unit outputs, as an output, an allocation matrix of a frequency channel that minimizes an interference penalty. The present system executes such complex calculations in parallel in a high-dimensional space. The present system exhibits a technical effect of realizing data-driven decision making that does not depend on human rules of thumb and dramatically improving operation efficiency of the entire system. The present system is applicable to fields such as dynamic resource allocation of a global satellite communication network and emergency network construction in the event of a wide-area disaster. The present system integrates inference results of each model by ensemble learning. The present system thereby offsets a prediction error of a single model and improves overall accuracy.

The optimization control unit has a function of transmitting, in real time, a control command such as frequency allocation, power distribution, dynamic adjustment of a communication area radius, switching to a backup frequency band, redundancy of a communication path, and allocation of priority communication to the stratospheric communication platform and the terminal based on an analysis result of the generative AI analysis unit. For example, when a weather fluctuation is severe, a communication area is reduced to maintain stable communication quality. When communication demand rapidly increases, a frequency band is expanded and optimal frequency allocation for avoiding interference is automatically determined. When a remaining battery level decreases, power distribution is reviewed and power is preferentially supplied to a highly important communication device. In the event of a disaster, a plurality of restoration measures such as switching to a backup frequency band, reconfiguration of a communication area, activation of a standby power supply, redundancy of a communication path, and allocation of priority communication are simultaneously executed. Specifically, the present control unit receives, as an input, structured data such as a prediction tensor and an optimization matrix output from the analysis unit. The present control unit includes a protocol conversion module configured to convert the input data into a low-layer control command interpretable by each hardware component. When deterioration of communication quality due to a weather fluctuation is predicted, the present control unit transmits a new phase control matrix to a phase shifter of a phased array antenna. The present control unit thereby physically narrows a beam width of the antenna, reduces a communication area radius, and improves received signal strength. When receiving a prediction distribution indicating a rapid increase in communication demand, the present control unit dynamically rewrites a center frequency and a bandwidth parameter of a software defined radio module. The present control unit updates a subcarrier allocation map of orthogonal frequency division multiple access in order to avoid interference with an adjacent cell. When receiving an abnormality score indicating a decrease in a remaining battery level, the present control unit transmits a control signal to a power management unit. The present control unit turns off a switch of a power supply line to an environmental sensor having low importance or a standby transceiver, and maintains power supply to a main communication processor. When receiving a flag indicating occurrence of a disaster, the present control unit immediately switches an RF switch to validate an antenna of a backup frequency band. The present control unit simultaneously updates a routing table to make a communication path redundant, changes a QoS setting, and sets a priority of an emergency packet to the highest. The present system transmits such a control command to each platform with a latency in milliseconds. The present system automates a physical response of the system to an environmental change. The present system brings about a technical effect of preventing communication disconnection and keeping service quality constant. The present system is applied to use cases such as flight controller cooperation of an unmanned aerial vehicle and dynamic power routing of a smart grid. The present system returns an execution result of the control command to the analysis unit as a feedback loop. The present system thereby improves next control accuracy.

The monitoring unit has a function of monitoring an operation status of the entire system in real time and detecting a sign of an abnormality or a failure at an early stage. For example, when a value of sensor data exceeds a threshold, when communication traffic rapidly increases, when a device temperature abnormally rises, when a remaining battery level rapidly decreases, and the like, various abnormality patterns are detected and notified to an administrator and the AI analysis unit. Furthermore, an operation status of the system and a transition of various parameters are visualized to provide a judgment material for operation optimization and failure response. Specifically, the present monitoring unit includes a complex event processing engine configured to continuously process time-series data streamed from the database unit on an in-memory database. The present monitoring unit receives, as input data, a numerical stream indicating a measurement value from each sensor and a text stream of a system log. The present monitoring unit calculates a statistic such as a moving average and a standard deviation for data of the latest 5 minutes in real time using a sliding window algorithm. The present monitoring unit determines whether or not the calculated statistic exceeds a predefined static threshold or a dynamic threshold dynamically set by a machine learning model. The present monitoring unit fires an abnormality detection event, for example, when a scalar value indicating a device temperature exceeds 85 degrees Celsius, or when a pattern in which a packet loss rate rapidly increases is detected by pattern matching. When an abnormality detection event occurs, the present monitoring unit generates an alert object including an ID of a corresponding device, a time stamp, and metadata indicating a type of abnormality. The present monitoring unit push-notifies the generated alert object to the AI analysis unit and a dashboard of the administrator via a message queuing system. The present monitoring unit generates drawing data for rendering various metrics indicating the operation status of the system as a time-series graph, a heat map, and a network topology diagram. The present system extracts a meaningful state change from a vast data stream with low delay. The present system exhibits a technical effect of converting a sign of a failure into a human-recognizable form and supporting rapid decision making. The present system is applicable to fields such as infrastructure monitoring of a large-scale data center and monitoring of an instrumentation control system of a plant. The present system analyzes a past alert history and learns a pattern of false detection. The present system thereby continuously improves accuracy of an alert.

The recovery unit has a function of rapidly and autonomously executing a restoration measure based on information from the generative AI analysis unit and the monitoring unit in the event of a failure or a disaster. For example, when a part of devices of the communication platform fails, a redundant communication path is automatically selected to ensure continuation of a communication service. When a remaining battery level rapidly decreases, a device with high power consumption is temporarily stopped to maintain only an important communication function. In the event of a disaster, it is also possible to preferentially allocate a band to communication with high priority (rescue activity and transmission of disaster prevention information) and temporarily restrict communication of general users. Furthermore, an execution history and an effect of the restoration measure are recorded and utilized for failure response from the next time onward. Specifically, the present recovery unit implements an autonomous fault-tolerant control logic based on a state transition machine. The present recovery unit receives, as an input, an alert object transmitted from the monitoring unit and structured data indicating a recommended restoration action output from the AI analysis unit. When receiving an alert indicating a failure of a main router of the communication platform, the present recovery unit generates a control command for transitioning an interface of a standby router to an active state. The present recovery unit forcibly transmits a link state update packet of a routing protocol, and converges a routing table of the entire network to a redundant path. When receiving data indicating a sudden drop in a battery voltage, the present recovery unit refers to an internal table mapping power consumption and importance of each hardware module. The present recovery unit outputs a control signal for cutting off a power relay of a module having low importance and high power consumption. When receiving an instruction to shift to a disaster mode, the present recovery unit executes a setting script for allocating a packet from a specific IP address band to an absolute priority queue to a packet scheduler of a network switch. The present recovery unit simultaneously lowers a token replenishment rate of a token bucket algorithm for traffic of general users, and physically restricts a band. The present recovery unit writes a sequence of the executed restoration command, a metrics vector indicating a system state before and after execution, and a flag indicating success or failure of restoration into the database unit as log data. The present system reuses this log data as teacher data for reward calculation of a reinforcement learning model. The present system avoids fatal downtime of the system without intervention of a human operator. The present system brings about a technical effect of improving self-healing capability of the system and enhancing resilience. The present system is applied to use cases such as control of a life support system of a space station and a fail-safe mechanism of an autonomous driving vehicle. The present system retains a plurality of fallback plans in preparation for a case where the restoration measure fails. The present system thereby maintains a minimum function under any circumstances.

The user interface unit provides an interface for a system administrator or an operation person in charge to grasp a state of the system and perform necessary settings and instructions. For example, an operation status of the stratospheric communication platform, a transition of various sensor data, an AI analysis result, contents of optimization control, a failure occurrence history, and the like are visualized on a dashboard. Furthermore, it is also possible for the administrator to manually transmit a control command, adjust an analysis parameter of the AI, and set a priority of a restoration measure. Specifically, the present user interface unit is implemented as a Web-based single page application, and performs bidirectional communication with a back-end server. The present interface unit receives drawing data transmitted from the monitoring unit in real time. The present interface unit analyzes the received data, and renders a three-dimensional position and communication coverage of the stratospheric communication platform on a browser. The present interface unit draws a time-series transition of various sensor data as a dynamic line graph, and superimposes and displays an abnormality score and a prediction distribution output by the AI analysis unit as a heat map and a probability density function. The present interface unit displays a history of a control command executed by the optimization control unit and a log of a restoration measure executed by the recovery unit as a timeline format component. The present interface unit provides an input form for the administrator to manually transmit a control command. The present interface unit serializes a parameter input by the administrator into a payload, and transmits it to the control unit via an API. The present interface unit provides a slider and an input field for adjusting a hyperparameter of an AI model. The present interface unit exports a priority rule of a restoration measure set by the administrator as a policy file, and applies it to the recovery unit. The present system converts an internal state of a complex system into visual information that can be intuitively grasped. The present system exhibits a technical effect of smoothing cooperative work between a human and a machine and improving efficiency of operation management. The present system is applicable to fields such as an operation center of a large-scale network and a ground control station of a drone group. The present system saves an operation history of the administrator as an audit log. The present system thereby enables tracking when a security incident occurs.

Specific examples of prompt sentences to be read by the generative AI necessary for carrying out the present invention include, for example, “Compare weather data of the same period in the past five years with current weather data, and predict a weather fluctuation for the next 24 hours”, “Predict a peak timing of communication demand and its scale in the next 12 hours from a communication traffic history of the latest one week and a current traffic situation”

“Determine whether there is a sign of a device failure from a transition of a remaining battery level and a change in device temperature, and propose a necessary restoration measure”, “Comprehensively analyze positions, weather situations, communication demands, and device states of a plurality of stratospheric communication platforms, and determine an optimal arrangement and resource allocation”

“Present an optimization plan for priority communication allocation and bandwidth control in the event of a disaster”, and the like. These prompt sentences are used as instructions for the generative AI to integrally analyze diverse data and realize optimal operation of the entire system and failure response. Specifically, the present system includes a tokenizer configured to convert these prompt sentences in natural language into a token sequence processable by a large language model. The present system provides structured data extracted from a database unit as a context together with the prompt sentence. The present system combines, for example, a time-series tensor of atmospheric pressure, temperature, and humidity for the past five years and a numerical vector indicating a current sensor measurement value as a prefix of the prompt in response to a prompt for weather fluctuation prediction. The present system inputs the combined input data to an encoder of a transformer model. The present system generates text data indicating a weather fluctuation for the next 24 hours and an array of predicted numerical data based on a probability distribution output from a decoder of the model. The present system provides a multidimensional array indicating a transition of the number of packets for the latest one week as a context in response to a prompt for communication demand prediction. The present system extracts, as an output, a timestamp indicating a peak timing and a scalar value indicating a predicted maximum bandwidth. The present system inputs a vector indicating a drop curve of a battery voltage and time-series data of a temperature sensor in response to a prompt for device failure determination. The present system outputs, as an output, a score from 0 to 1 indicating a failure probability and a script of a recommended restoration command. The present system inputs a three-dimensional coordinate matrix of each platform and a communication demand heat map in response to a prompt for optimal arrangement. The present system outputs, as an output, a vector group indicating a destination coordinate of each platform and a frequency allocation table. The present system inputs a list of IP addresses to be prioritized and a current bandwidth usage situation in response to a prompt in the event of a disaster. The present system outputs, as an output, a command line character string for updating a QoS setting of a router. The present system parses the output text and structured data, and converts them into a machine language instruction set executable by a subsequent control unit and recovery unit. The present system abstracts complex system control via a natural language interface. The present system brings about a technical effect of enabling even an operator having no specialized knowledge of programming to execute advanced system optimization. The present system is applied to use cases such as next-generation intent-based network management and a human-machine interface of an autonomous system. The present system evaluates an execution result of the prompt, and automatically performs prompt optimization for drawing out a more highly accurate answer. The present system thereby maximizes the performance of the language model.

### Implementation Steps

Step 1: Collection of Sensor Data

A weather sensor, a communication traffic sensor, and a device state sensor mounted on a stratospheric communication platform acquire a wide variety of data such as temperature, atmospheric pressure, humidity, wind speed, precipitation, solar radiation, lightning detection, ozone concentration, the number of communication packets, communication band usage, the number of terminal connections, communication delay, a packet loss rate, a remaining battery level, a power generation amount, power consumption, a device temperature, a hardware abnormality, a software error, a memory usage rate, and a remaining storage capacity in real time, and transmit the data to a ground server at regular intervals. For example, the data is collected without omission under all circumstances, such as when a rapid temperature drop is detected in a mountainous area, when the number of terminal connections rapidly increases during a tourist season on a remote island, or when a remaining battery level decreases. Specifically, the present system converts an analog signal output from each sensor into digital data. The present system dynamically adjusts a sampling rate. The present system formats the acquired data as a multidimensional tensor. The present system stores, for example, temperature data as a one-dimensional array of floating-point numbers. The present system configures communication traffic data as a time-series two-dimensional matrix. The present system preprocesses these data using an edge computing technology. The present system applies a noise removal filter. The present system complements a missing value with a linear interpolation algorithm. The present system packetizes the preprocessed data. The present system adds a timestamp and position information to a packet header. The present system transmits the data from a high-altitude platform to the ground server. The present system optimizes a bandwidth using a multiplexing technology. The present system enhances the comprehensiveness of data collection. The present system eliminates a blind spot of a communication infrastructure. The present system is applied to use cases such as a distress rescue operation in a mountainous area and remote medical support on a remote island. The present system enables real-time situation grasping. The present system suppresses a delay in data transmission to a millisecond unit. The present system dramatically improves a response speed of the entire system.
Step 2: Accumulation and Management of Data

A database unit on a server side accumulates and manages all data transmitted from a sensor data collection unit in chronological order. This includes weather data, communication traffic data, and device state data for the past several years, urban infrastructure data and demographic data acquired from the outside, and the like, and history data at the time of holding an event or occurrence of a disaster, a failure history for each device, and data of an external disaster prevention sensor and a traffic sensor are also integrally managed. Specifically, the present database unit adopts a hybrid configuration combining a distributed relational database and a non-relational database. The present database unit includes a dedicated engine for efficiently storing time-series data. The present database unit parses received packet data. The present database unit converts the data into a feature vector. The present database unit saves, for example, weather data as a multidimensional array with a spatial index. The present database unit stores communication traffic data as graph structure data. The present database unit executes a normalization process of the data. The present database unit standardizes data of different scales to a mean of zero and a variance of one. The present database unit executes an outlier detection algorithm in the background. The present database unit adds a flag to a statistically significant outlier. The present database unit uses an in-memory cache to improve a data search speed. The present database unit processes petabyte-class big data at high speed. The present database unit shortens a latency of data access to a microsecond order. The present database unit is applied to use cases such as traffic control in a smart city and grasping of a damage situation in the event of a wide-area disaster. The present database unit provides high-quality learning data to a subsequent AI analysis unit. The present database unit contributes to an improvement in prediction accuracy of the entire system.
Step 3: Integrated Analysis and Prediction by Generative AI

A generative AI analysis unit executes prediction of weather fluctuation, prediction of communication demand, detection of device abnormality, optimization calculation, and the like using a vast amount of data accumulated in a database unit. For example, past weather data and current weather data are compared to predict a weather fluctuation for the next few hours to few days with high accuracy, a rapid increase in future communication demand and a change in a communication pattern are predicted from a communication traffic history and a current situation, and a sign of a device failure is detected from a transition of a remaining battery level and a change in device temperature. Furthermore, positions, weather situations, communication demands, and device states of a plurality of stratospheric communication platforms are comprehensively analyzed to determine an optimal arrangement and resource allocation. Specific examples of prompt sentences to be read by the generative AI include “Compare weather data of the same period in the past five years with current weather data, and predict a weather fluctuation for the next 24 hours”, “Predict a peak timing of communication demand and its scale in the next 12 hours from a communication traffic history of the latest one week and a current traffic situation”, “Determine whether there is a sign of a device failure from a transition of a remaining battery level and a change in device temperature, and propose a necessary restoration measure”, “Comprehensively analyze positions, weather situations, communication demands, and device states of a plurality of stratospheric communication platforms, and determine an optimal arrangement and resource allocation”, and “Present an optimization plan for priority communication allocation and bandwidth control in the event of a disaster”. Specifically, the present generative AI analysis unit implements a large language model and a time-series prediction model based on a transformer architecture equipped with a self-attention mechanism. The present generative AI analysis unit receives a multidimensional tensor extracted from the database unit as an input. Input data to the present generative AI analysis unit is, for example, a two-dimensional tensor having a shape of 128 rows and 64 columns including temperature, atmospheric pressure, and the number of communication packets for the past seven days. Specific examples of the input data to the present generative AI analysis unit include a floating-point vector indicating a temperature of minus five degrees Celsius and a numerical array indicating a communication band usage rate of 80 percent. The present generative AI analysis unit adds positional encoding to the input data. The present generative AI analysis unit calculates a hidden state vector through a multi-layer neural network. The present generative AI analysis unit is pre-trained using a gradient descent method that minimizes a mean square error. The present generative AI analysis unit generates a probability distribution tensor indicating a future predicted value as an output. Specific examples of output data from the present generative AI analysis unit include a score value indicating that a probability that communication demand in the next two hours will double from the current level is 95 percent, and label data indicating that a probability that a specific communication module will fail is 80 percent. The present generative AI analysis unit transmits these output results to a subsequent optimization control unit. The present system performs threshold determination using this prediction result. The present system fires an alert when a prediction score exceeds a prescribed threshold. The present system executes non-linear pattern recognition in a high-dimensional space. The present system captures a minute environmental change impossible by human intuition. The present system is applied to use cases such as communication congestion avoidance during a large-scale event and infrastructure protection when a typhoon approaches. The present system realizes proactive system control. The present system reduces downtime of a communication service to the utmost limit.
Step 4: Transmission of Optimization Control Command

An optimization control unit transmits, in real time, a control command such as frequency allocation, power distribution, dynamic adjustment of a communication area radius, switching to a backup frequency band, redundancy of a communication path, and allocation of priority communication to a stratospheric communication platform and a terminal based on an analysis result of a generative AI analysis unit. For example, when a weather fluctuation is severe, a communication area is reduced, when communication demand rapidly increases, a frequency band is expanded, when a remaining battery level decreases, power distribution is reviewed, and in the event of a disaster, a plurality of restoration measures such as switching to a backup frequency band, reconfiguration of a communication area, and activation of a standby power supply are simultaneously executed. Specifically, the present optimization control unit includes an agent based on a reinforcement learning algorithm. The present optimization control unit receives a prediction score and a probability distribution tensor output from the generative AI analysis unit as a state vector. The present optimization control unit calculates an optimal action-value function using a Markov decision process model. The present optimization control unit sets maximization of communication throughput and minimization of power consumption as a reward function. The present optimization control unit outputs a multidimensional vector including a specific control parameter based on the calculated action-value function. The present optimization control unit generates, for example, numerical data designating a frequency band in units of megahertz and a radian value indicating a directivity angle of an antenna. The present optimization control unit encodes these control parameters into a control command packet in a binary format. The present optimization control unit transmits the control command packet to each hardware module of the stratospheric communication platform. The present system physically drives a phase shifter of a phased array antenna based on the received control command. The present system dynamically changes beamforming of a communication area. The present system switches a modulation scheme in real time using a software defined radio technology. The present system directly controls a physical operation of hardware. The present system optimizes a physical configuration of a computer system itself, rather than mere information presentation. The present system is applied to use cases such as compensation for radio wave attenuation accompanying a localized heavy rain and securing of an emergency communication line to a disaster-stricken area. The present system prevents deterioration of communication quality in advance. The present system provides a maximum communication capacity with limited resources.
Step 5: Monitoring of System Operation Status and Failure Response

A monitoring unit monitors an operation status of the entire system in real time, and detects a sign of an abnormality or a failure at an early stage. For example, various abnormality patterns are detected, such as when a value of sensor data exceeds a threshold, when communication traffic rapidly increases, when a device temperature abnormally rises, or when a remaining battery level rapidly decreases, and an administrator and an AI analysis unit are notified. A recovery unit rapidly and autonomously executes a restoration measure based on information from a generative AI analysis unit and the monitoring unit in the event of a failure or a disaster, and ensures continuation of a communication service. Specifically, the present monitoring unit executes ingest of real-time data using a stream processing engine. The present monitoring unit applies a statistical process of a sliding window method to a received sensor data stream. The present monitoring unit calculates a moving average and a standard deviation of each data point. The present monitoring unit compares a calculation result with a dynamic threshold. The present monitoring unit executes an abnormality detection algorithm using a Mahalanobis distance. The present monitoring unit calculates a distance of a data point in a multidimensional feature space. The present monitoring unit generates an abnormality flag when the distance exceeds a predetermined threshold. The present recovery unit starts a failover process immediately upon receiving the abnormality flag. The present recovery unit cuts off power supply to a failed module. The present recovery unit activates a redundant standby module. The present recovery unit rewrites a routing table. The present recovery unit detours traffic to a normal path. The present system completes these restoration processes in a millisecond unit without human intervention. The present system maintains availability of the system at a nines level. The present system eliminates a single point of failure of hardware. The present system is applied to use cases such as unmanned operation in a harsh environment close to outer space and maintenance of a communication infrastructure on the ocean where maintenance is difficult. The present system dramatically shortens a time from occurrence of a failure to restoration. The present system ensures continuity of mission-critical communication.
Step 6: Operation Management by User Interface

A user interface unit visualizes an operation status of a stratospheric communication platform, a transition of various sensor data, an AI analysis result, content of optimization control, a failure occurrence history, and the like for a system administrator and an operation person in charge, and enables the administrator to manually transmit a control command, adjust an analysis parameter of an AI, and set a priority of a restoration measure. Specifically, the present user interface unit includes a three-dimensional graphics rendering engine. The present user interface unit maps multidimensional data acquired from a database unit and a monitoring unit to a visual object. The present user interface unit draws a spatial arrangement of the stratospheric communication platform on a three-dimensional coordinate system. The present user interface unit expresses a density of communication traffic as a color gradation. The present user interface unit captures an operation event from an input device of the administrator. The present user interface unit converts the operation event into a structured control command. The present user interface unit transmits the control command to an optimization control unit via a secure communication interface. The present user interface unit provides a hyperparameter adjustment screen of the AI. The present user interface unit enables a numerical value such as a learning rate and a batch size to be intuitively changed with a slider. The present system seamlessly reflects an intention of the administrator in physical control inside the system. The present system enables a complex system state to be intuitively grasped. The present system reduces a cognitive load. The present system is applied to use cases such as integrated monitoring of a wide area network across a plurality of cities and operation management of an international communication infrastructure. The present system prevents a human error. The present system dramatically improves operation efficiency.

### Specific Use Case

For example, a use case aimed at providing a communication infrastructure in a mountainous area is assumed. In this case, a stratospheric communication platform is arranged over the mountainous area, and a weather sensor for temperature, atmospheric pressure, humidity, wind speed, precipitation, solar radiation, lightning detection, ozone concentration, and the like, a communication traffic sensor for the number of communication packets, communication band usage, the number of terminal connections, communication delay, a packet loss rate, and the like, and a device state sensor for a remaining battery level, a power generation amount, power consumption, a device temperature, a hardware abnormality, a software error, and the like acquire data in real time. For example, various situations are assumed, such as when a rapid temperature drop or a strong wind is observed in winter, when the number of terminal connections rapidly increases during a tourist season, or when communication demand suddenly increases in the event of a disaster such as a mountain distress. Specifically, the present system executes a dedicated algorithm for coping with a complex terrain and a rapid weather change peculiar to the mountainous area. The present system loads a three-dimensional digital map including terrain elevation data onto a memory. The present system executes a propagation simulation of a radio wave in real time using a current position coordinate of the stratospheric communication platform and the terrain data. The present system calculates reflection and diffraction of the radio wave using a ray tracing method. The present system formats data acquired from each sensor as a multidimensional time-series tensor. The present system arrays, for example, temperature data as a floating-point number in units of Celsius. The present system stores wind speed data as vector data in meters per second. The present system primarily processes these environmental data on an edge device side. The present system removes a noise component using a Kalman filter. The present system transmits the cleaned data to a ground server. The present system dynamically specifies a dead zone of the radio wave in the mountainous area. The present system captures a weak beacon signal emitted from a smartphone of a person in distress with high sensitivity. The present system is applied to use cases such as distress rescue support in winter mountain climbing and securing of emergency communication in the event of a landslide disaster in a mountainous area. The present system maintains a stable communication link even under a harsh natural environment. The present system improves certainty of critical information transmission related to lifesaving.

Under such circumstances, a vast amount of data acquired by the sensor data collection unit is accumulated in the database unit on the server side via the data transmission unit. The database unit manages weather data, communication traffic data, and device state data for the past several years in chronological order, and integrally retains history data at the time of holding an event or occurrence of a disaster. The generative AI analysis unit performs an integrated analysis using these data by using a prompt sentence such as, for example, “Compare weather data in the same period for the past five years with current weather data, and predict a weather fluctuation for the next 24 hours,” “Predict a peak timing of communication demand and its scale in the next 12 hours from a communication traffic history for the latest one week and a current traffic situation,” or “Determine whether there is a sign of a device failure from a transition of a remaining battery level and a change in device temperature, and propose a necessary restoration measure.” Specifically, the database unit stores the received multidimensional time-series tensor on a distributed file system in units of blocks. The database unit calculates a hash value for each data block to prevent data falsification. The generative AI analysis unit implements a multimodal neural network in which a natural language processing technology and a time-series analysis technology are fused. The generative AI analysis unit tokenizes the prompt sentence and converts it into an embedding vector. Input data to the generative AI analysis unit is, for example, a two-dimensional tensor having a shape of 500 rows and 10 columns including weather data for the past 500 days, and the embedding vector of the prompt sentence. Specific examples of the input data to the generative AI analysis unit include a time-series array indicating a rapid temperature drop and a numerical vector indicating a spike in communication traffic. The generative AI analysis unit calculates a correlation between the text vector and the time-series tensor using a cross-attention mechanism. The generative AI analysis unit predicts a future system state. The generative AI analysis unit generates, as an output, a one-dimensional tensor indicating a failure probability of each device and structured data including a recommended control parameter. Specific examples of output data from the generative AI analysis unit include a score value indicating that a battery depletion probability is 90 percent and numerical data indicating that a communication area radius should be reduced by five kilometers. The system inputs these output results to a subsequent control logic. The system elucidates a complex causal relationship in a high-dimensional space. The system is applied to a use case such as communication optimization in a peak season at a mountain resort or maintenance of a sensor network for monitoring volcanic activity. The system realizes data-driven autonomous system operation. The system improves system reliability while reducing an operation cost.

For example, when the temperature rapidly drops at night in winter and a strong wind is observed at the same time, the generative AI collates a past weather pattern with current data, and predicts a risk that battery consumption of a communication device will accelerate in the next few hours and a possibility of a malfunction due to an abnormal drop in device temperature. Based on this, the optimization control unit temporarily reduces a communication area radius, limits operation of a device with high power consumption, and transmits a control command to maintain only an important communication function. In addition, when the number of terminal connections rapidly increases in a tourist season, the generative AI predicts a peak timing and a scale of communication demand from a past traffic history and a current situation, expands a frequency band in advance, and determines optimal frequency allocation for avoiding interference. Furthermore, in the event of a disaster such as a mountain accident, the generative AI immediately detects an abnormality from sensor data, and simultaneously executes a plurality of restoration measures such as switching to a backup frequency band, reconfiguration of a communication area, activation of a standby power supply, and allocation of priority communication. Specifically, the optimization control unit receives the failure probability score and the recommended parameter output from the generative AI analysis unit. The optimization control unit generates a control matrix for changing a physical operation state of hardware based on the received data. The optimization control unit calculates, for example, numerical data designating an output of a battery heater in units of watts and a parameter for adjusting a gain of a transmission amplifier in units of decibels. The optimization control unit transmits these parameters as a control packet to the stratospheric communication platform. Upon receiving the control packet, the system changes a switching frequency of a power supply circuit via an internal microcontroller. The system physically cuts off power supply to a specific communication module. The system electronically controls directivity of a phased array antenna, and concentrates a communication area around a specific mountain hut. The system reconfigures a software-defined radio module when a disaster is detected. The system starts transmission and reception processing in a specific frequency band for emergency. The system rewrites a setting of a packet scheduler, and assigns a tag of the highest priority to a packet from a terminal of a rescue team. The system dynamically optimizes operations of a physical layer and a data link layer. The system is applied to a use case such as securing an emergency contact network in the event of an avalanche or tracking position information of a victim. The system concentrates limited power resources on the most important function. The system maximizes a system survival probability under an extreme environment.

In such a use case, specific examples of the prompt sentence to be read by the generative AI include “Compare winter weather data for the past five years in a stratospheric communication platform over a mountainous area with current weather data, and predict a weather fluctuation for the next 12 hours and an influence on a communication device,” “Calculate a peak timing of communication demand and a necessary frequency band in the next 24 hours from a transition of the number of terminal connections in a tourist season and a past traffic history,” “Detect a sign of a device failure from a transition of a remaining battery level, a change in device temperature, and an occurrence frequency of a hardware abnormality, and propose a necessary restoration measure,” and “Present an optimization plan for allocation of priority communication and band control in the event of a disaster.” Specifically, the generative AI analysis unit parses the input prompt sentence using a natural language processing engine. The generative AI analysis unit specifies an intention and an entity to be extracted from the prompt sentence. The generative AI analysis unit automatically generates a query to be issued to the database unit based on the specified entity. The generative AI analysis unit encodes the multidimensional tensor acquired as a query result as a context vector. Input data to the generative AI analysis unit is, for example, a two-dimensional tensor having a shape of 1800 rows and 20 columns including winter weather data for the past five years. Specific examples of the input data to the generative AI analysis unit include a temperature vector indicating 20 degrees below freezing and a wind speed vector indicating a wind speed of 30 meters per second. The generative AI analysis unit generates text data including a prediction result and structured data for control using a decoder unit of a transformer model. The generative AI analysis unit generates, as an output, a time-series array indicating a temperature transition for the next 12 hours and numerical data in units of megahertz indicating a necessary frequency bandwidth. Specific examples of output data from the generative AI analysis unit include a time stamp indicating that a peak of communication demand arrives at 2:00 p.m. and a Boolean value instructing activation of a standby power supply. The system parses these outputs and passes them to the subsequent optimization control unit. The system converts an instruction in human natural language into a physical control command of a computer. The system makes it possible to flexibly change a behavior of the system without complex programming. The system is applied to a use case such as an immediate change of a communication area by a voice instruction from a mountain guide or execution of an advance measure based on text input by a weather forecaster. The system advances an interface between a human and a machine. The system dramatically enhances operation flexibility of the system.

As described above, the system of the present invention can realize optimal operation of a communication infrastructure and a high communication continuation rate in real time and autonomously in various use cases such as a mountainous area, a remote island, an urban area in an emerging market, a disaster site, an event venue, a smart city, and an IoT platform, by cooperation of the stratospheric communication platform, the server, the terminal, various sensors, the generative AI analysis unit, the optimization control unit, the monitoring unit, the recovery unit, and the user interface unit. Specifically, the system connects the respective components with a low-delay optical communication link and a microwave communication link. The system adopts a distributed computing architecture. The system dynamically distributes a calculation load between an edge node and a cloud server. The system deploys each function as an independent container based on a microservice architecture. The system facilitates scale-out of the entire system. The system integrates a new sensor device or communication protocol into the system by plug and play even when it is added. The system constructs a continuous integration and continuous deployment pipeline of a machine learning model. The system periodically relearns a weight parameter of the model using newly collected data. The system continuously improves prediction accuracy by adapting to a change in environment. The system realizes optimization of a physical world beyond mere data processing by close cooperation between hardware and software. The system is applied to a use case such as environmental monitoring of a wide-area agricultural field in smart agriculture or a low-delay communication platform for group control of autonomous vehicles. The system significantly reduces a cost required for construction and maintenance of a communication infrastructure. The system contributes to elimination of an information gap and construction of a resilient social infrastructure.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described extremely specifically and comprehensively regarding a configuration and an operation of an integrated urban infrastructure optimization system. The system of the present invention is composed of a stratospheric communication platform, a wide variety of sensor devices in a city, a data transmission unit, a database unit, a generative AI analysis unit, an optimization control unit, various urban infrastructure control units, a monitoring unit, a recovery unit, a user interface unit, and the like. Specifically, the system includes an integrated data platform for reconstructing an entire urban space as a digital twin in a virtual space. The system interconnects the respective components with a gigabit-class broadband backbone network. The system allocates a unique network address to each sensor device. The system implements an end-to-end encrypted communication protocol. The system analyzes header information of a packet and executes priority control of traffic in the data transmission unit. The system constructs a distributed hash table capable of processing petabyte-class data in the database unit. The system causes the generative AI analysis unit to perform ensemble learning of a plurality of neural network models. The system executes a solver based on nonlinear programming in the optimization control unit. The system issues a control command to the various urban infrastructure control units via a standardized interface. The system executes a health check of the entire system in units of milliseconds in the monitoring unit. The system automates a rollback process in the event of a failure in the recovery unit. The system is applied to a use case such as drastic elimination of traffic congestion in a megacity or fully automatic adjustment of power supply and demand in a smart grid. The system breaks down a silo of an urban infrastructure. The system maximizes energy efficiency and operation efficiency of the entire city.

The stratospheric communication platform is arranged over a city, aggregates sensor data of a wide range of urban infrastructure from the ground, and realizes high-speed and stable communication with a ground server. For example, a plurality of stratospheric communication platforms can be arranged so as to cover the entire city, such as from a center of the city to a suburb, an industrial area, a residential area, a commercial area, a port area, an airport periphery, a river basin, and a mountainous area. This makes it possible to acquire data and transmit a control command in real time in any area in the city. Specifically, the stratospheric communication platform is configured as an autonomous flight type unmanned aerial vehicle equipped with a solar panel and a large-capacity battery. The stratospheric communication platform estimates its own position with high accuracy using a satellite positioning system and an inertial navigation system. The stratospheric communication platform controls an output of a propulsion device using an onboard flight controller, and maintains a predetermined staying airspace. The stratospheric communication platform is equipped with a multi-beam antenna that irradiates a plurality of spot beams toward the ground. The stratospheric communication platform electronically controls an irradiation angle and an output of each beam. The stratospheric communication platform dynamically deforms a footprint of the beam in accordance with a population density of the city and a distribution of communication traffic. The stratospheric communication platform establishes an optical space communication link with an adjacent platform. The stratospheric communication platform forms a mesh network. The system is applied to a use case such as a disaster area of a large-scale earthquake where a ground infrastructure is destroyed or a wide urban area including a steep mountainous area where laying an optical fiber is difficult. The system eliminates a physical constraint of a ground network. The system provides seamless and robust communication coverage covering the entire city.

Sensor devices in the city are installed in various infrastructure areas such as traffic, energy, environment, disaster prevention, and communication. For example, a traffic sensor is installed at a major intersection, an arterial road, a bypass, a tunnel, a bridge, a parking lot, a bus terminal, a railway station, a subway platform, an airport terminal, a port facility, or the like, and acquires the number of vehicles, a traffic volume by vehicle type, an average speed, a congestion level, a signal waiting time, accident occurrence information, a public transportation use situation, operation delay information of a bus or a railway, an availability situation of a parking lot, and the like. For example, an energy sensor is installed in a power plant, a substation, a switchboard, a building, a house, a factory, a commercial facility, a renewable energy power generation facility (solar power, wind power, small hydropower, biomass, etc.), or the like, and acquires power consumption, a power generation amount, a renewable energy ratio, a system voltage/current, an operation status of a power system, system failure occurrence information, a remaining storage battery level, peak power demand, and the like. For example, an air quality sensor, a temperature/humidity sensor, a noise sensor, a dust sensor, a carbon dioxide sensor, a PM2.5 sensor, an odor sensor, an ultraviolet sensor, or the like is installed along a road, in an industrial area, a residential area, a school, a hospital, a park, a tourist spot, or the like, and acquires environmental data such as a PM2.5 concentration, a carbon dioxide concentration, a temperature, a humidity, a noise level, odor detection, an ultraviolet amount, and a pollen scattering amount. For example, a river water level gauge, a seismometer, a weather sensor, a landslide sensor, a fire alarm, a tsunami sensor, an evacuation center entry/exit sensor, or the like is installed in a river basin, a mountainous area, a coastal area, a city center, a residential area, a public facility, or the like, and acquires disaster prevention-related data such as a water level, a seismic waveform, a rainfall amount, a wind speed, a sediment runoff amount, fire occurrence information, a tsunami arrival prediction, and an evacuation center congestion situation. Furthermore, an operation status of a communication device, a remaining battery level, failure occurrence information, a communication band usage rate, the number of terminal connections, a communication delay, a packet loss rate, and the like are acquired from a communication base station, an IoT gateway, a Wi-Fi access point, an LPWA base station, a terminal device, and the like. Specifically, the system converts an analog signal output from these millions of heterogeneous sensor devices into digital data at an edge gateway. The system serializes each sensor data into a structured object having a specific format. The system analyzes, for example, video data from the traffic sensor on an edge side using a convolutional neural network. The system extracts bounding box coordinates of a vehicle and a vehicle type class label from the video. The system transmits only the extracted metadata as a multidimensional tensor to the server. The system converts time-series data from the energy sensor into frequency domain data using a fast Fourier transform. The system digitizes a minute voltage change from the environmental sensor with a high-precision converter. The system transmits a trigger signal from the disaster prevention sensor to a system kernel as an interrupt process with the highest priority. The system dramatically reduces consumption of a network band by these preprocesses. The system is applied to a use case such as intersection passage support for an autonomous vehicle or real-time diffusion prediction of a harmful substance in an industrial area. The system digitizes a physical state of the city with extremely high spatial and temporal resolution. The system fundamentally improves accuracy of subsequent AI analysis.

The data transmission unit aggregates these vast amounts of sensor data to the ground server via the stratospheric communication platform, and performs advanced transmission control such as data compression, dynamic adjustment of a transmission interval in accordance with a communication band or a network situation, priority transmission in accordance with importance, redundant path selection in the event of a disaster, data encryption/decryption, and retransmission control in the event of data loss. For example, in the event of a disaster, important disaster prevention data and communication failure information are transmitted with the highest priority, and in normal times, a communication band is efficiently used by utilizing batch transmission and data compression. Specifically, the data transmission unit separates a data plane and a control plane using a software-defined network technology. The data transmission unit applies a lossless compression algorithm to a payload of each packet. The data transmission unit monitors a queue length and a delay time indicating a congestion state of a network in real time. The data transmission unit calculates an optimal routing path using a reinforcement learning agent. The data transmission unit dynamically rewrites a forwarding table of each router based on a calculation result. The data transmission unit adds a forward error correction code to disaster prevention data with high importance. The data transmission unit executes link aggregation that bundles a plurality of physical links. The data transmission unit encrypts the payload using an advanced encryption standard algorithm at the time of data transmission. The data transmission unit verifies data integrity using a hash function on a receiving side. When detecting a packet loss, the data transmission unit re-requests only a missing packet based on an automatic repeat request protocol. The system is applied to a use case such as communication between data centers of a financial institution or ultra-low delay video transmission in remote surgery. The system maximizes efficiency of a limited wireless band. The system guarantees data arrival certainty and security at the highest level.

The database unit accumulates and manages all received data in chronological order, and integrally manages weather data, traffic data, energy data, environmental data, disaster prevention data, and communication data for the past several years, urban infrastructure data and demographic data acquired from the outside, history data at the time of holding an event or occurrence of a disaster, a failure history for each device, city planning information, road construction information, an event schedule, a resident questionnaire result, and the like. For example, a traffic congestion pattern at the time of holding a past large-scale event, a power outage occurrence situation at the time of a past typhoon strike, a factory operation situation at the time of issuing a past air pollution warning, and the like are recorded and analyzed in detail. Specifically, the database unit adopts a data lake architecture that integrally handles structured data and unstructured data. The database unit applies a columnar format to time-series data, and minimizes writing to a disk. The database unit adds a spatial index and a temporal index to each data record. The database unit constructs an index tree using a tree structure algorithm. The database unit vectorizes a resident questionnaire result and text data described in natural language using a large language model. The database unit stores the generated high-dimensional vector in a vector database. The database unit searches for data related to a specific event at high speed using cosine similarity calculation. The database unit automatically archives old data to a cold storage based on a data lifecycle management policy. The database unit executes a data deduplication process in the background. The system is applied to a use case such as human flow analysis during a pandemic or an environmental assessment in a large-scale redevelopment project. The system makes it possible to cross-search data of heterogeneous formats with a single query. The system significantly reduces latency of data extraction, and supports real-time decision making.

The generative AI analysis unit predicts a situation change and an abnormality occurrence of the entire city with high accuracy using a vast amount of data accumulated in the database unit, and executes various optimization calculations. For example, past traffic data is compared with current traffic data to predict and determine a traffic congestion occurrence risk for the next few hours to few days, an optimal signal control plan, a public transportation increase timing, a parking lot guidance plan, warning transmission of an accident-prone point, and the like. For example, regarding energy data, a power saving request timing at the next peak, an activation condition of an emergency power supply, selection of a power accommodation destination, a charge/discharge plan of a storage battery, and the like are calculated from a past power consumption pattern, a renewable energy ratio, a current system load situation, and weather prediction data. For example, regarding environmental data, an air pollution deterioration risk for the next six hours, a necessary traffic restriction measure, a factory operation suppression plan, a transmission timing of a health damage warning to residents, and the like are derived from time-series data of an air quality sensor, weather data, traffic volume data, and factory operation data. For example, regarding disaster prevention data, an emergency warning issuance timing in the event of a disaster, optimization of an evacuation guidance route, a congestion mitigation measure for an evacuation center, a relief supply delivery plan, and the like are determined from an abnormal value of a seismometer or a river water level gauge, warning data of the Japan Meteorological Agency, SNS post data, and the like. For example, regarding communication data, a switching condition to a backup communication path, allocation of a priority communication band, a network load distribution plan, an automatic restoration procedure in the event of a failure, and the like are optimized from a remaining battery level of a communication device, a failure occurrence history, the number of terminal connections, a communication band usage rate, and network topology information. Specifically, the generative AI analysis unit implements a deep learning model combining a graph convolutional network and a long short-term memory network. Input data to the generative AI analysis unit is an adjacency matrix tensor expressing a road network or a power network of the city, and a feature amount tensor including time-series sensor data at each node. Specific examples of the input data to the generative AI analysis unit include a 100-dimensional integer vector indicating the number of vehicles at an intersection and a floating-point array indicating a voltage value of a substation. The generative AI analysis unit simultaneously learns a spatial dependency relationship on a graph structure and a temporal dependency relationship on a time series. The generative AI analysis unit optimizes a weight parameter of a network using an error backpropagation algorithm. The generative AI analysis unit generates, as an output, a prediction tensor indicating a future state at each node and heat map data indicating an abnormality occurrence probability. Specific examples of output data from the generative AI analysis unit include a score value indicating that a probability of occurrence of congestion at a specific intersection after one hour is 85 percent and a clustering label indicating that a power outage risk is high in a specific power distribution section. The generative AI analysis unit transmits these output results to the subsequent optimization control unit. The system automatically generates an alert when a prediction score exceeds a reference value using a threshold determination logic. The system is applied to a use case such as calculation of dynamic pricing in a smart city or prediction of underground mall flooding during a guerrilla rainstorm. The system mathematically models a complex interaction of an urban infrastructure. The system realizes highly accurate future prediction that does not depend on a human rule of thumb.

The optimization control unit automatically transmits a specific control command to each urban infrastructure control unit such as a traffic signal control system, a public transportation operation management system, a power system control system, an environmental regulation system, a disaster prevention information distribution system, and a communication network control system based on an analysis result of the generative AI analysis unit. For example, when traffic congestion is predicted during morning and evening rush hours, the optimization control unit dynamically changes a signal control timing, instructs a public transportation increase, and reflects an availability status in a parking lot guidance system. For example, when power consumption reaches a peak and a power system is overloaded, the optimization control unit determines a power saving request, priority use of renewable energy, activation of an emergency power supply, charge/discharge switching of a storage battery, and a peak cut instruction to a factory or a large commercial facility. For example, when air pollution exceeds a reference value, the optimization control unit automatically executes a traffic restriction in a specific area, factory operation suppression, warning issuance to residents, and an air purifier operation instruction to a school or a hospital. For example, when a disaster such as an earthquake, a flood, or a rainstorm is detected, the optimization control unit immediately executes emergency warning issuance, evacuation guidance, priority power supply to critical infrastructure, redundancy of a communication network, optimization of a relief supply delivery route, a congestion mitigation measure for an evacuation shelter, and the like. For example, when a failure or a battery drop occurs in a communication device, the optimization control unit instructs switching to a backup communication path, priority band allocation to important communication, reconfiguration of a network topology, and automatic detection and notification of a failure occurrence location, and ensures communication continuation of the entire city. Specifically, the optimization control unit includes a mixed integer linear programming solver. The optimization control unit inputs a prediction tensor and an abnormality probability score output from the generative AI analysis unit as a coefficient of an objective function. The optimization control unit formulates a physical constraint and an operation rule of the urban infrastructure as a constraint equation. The optimization control unit searches for an optimal solution using a branch and bound method. The optimization control unit generates a control parameter vector for driving each actuator based on the calculated optimal solution. The optimization control unit generates, for example, seconds data indicating a green time of a traffic signal and numerical data in kilowatts indicating discharge power of a storage battery. The optimization control unit encapsulates these parameters into a packet compliant with an industrial control protocol. The optimization control unit transmits the packet to a programmable logic controller of each infrastructure control unit. The system physically opens and closes a relay circuit of a traffic light based on the received packet. The system remotely operates a circuit breaker of a substation. The system activates a speaker amplifier of a siren. The system is applied to a use case such as spectator guidance at the end of a large-scale sports event or avoidance of a wide-area blackout on an extremely hot day. The system directly converts a calculation result in a cyberspace into a physical change in a physical space. The system optimizes operation efficiency of the entire city in real time and autonomously.

The monitoring unit monitors an operation status of the entire system in real time, and detects a sign of an abnormality or a failure early. For example, when a value of sensor data exceeds a threshold, when communication traffic rapidly increases, when a device temperature abnormally rises, when a remaining battery level rapidly drops, or when there is an abnormality report by a complaint from a resident or an SNS post, the monitoring unit detects various abnormality patterns and notifies an administrator and the AI analysis unit. The recovery unit rapidly and autonomously executes a restoration measure based on information from the generative AI analysis unit and the monitoring unit in the event of a failure or a disaster, and ensures continuation of a communication service and urban infrastructure. For example, when some devices of the communication platform fail, the recovery unit automatically selects a redundant communication path and ensures the continuation of the communication service. When the remaining battery level rapidly drops, the recovery unit temporarily stops a device with high power consumption and maintains only an important communication function. In the event of a disaster, it is also possible to preferentially allocate a band to communication with high priority (rescue operation and transmission of disaster prevention information) and temporarily restrict communication of a general user. When congestion of an evacuation shelter is predicted, the recovery unit automatically transmits a notification prompting residents to perform distributed evacuation. Specifically, the monitoring unit collects a communication log between microservices in milliseconds using a distributed tracing system. The monitoring unit applies an unsupervised learning model using an autoencoder to the collected log data. The monitoring unit calculates a reconstruction error deviating from a normal data pattern. The monitoring unit fires an abnormality detection event when the reconstruction error exceeds a dynamically set threshold. The recovery unit executes an automatic restoration script based on a predefined playbook using the abnormality detection event as a trigger. The recovery unit issues a system call to a container management tool. The recovery unit forcibly terminates a software container in which an abnormality is detected. The recovery unit activates a new container instance on a healthy node. The recovery unit dynamically updates a setting of a load balancer and routes traffic to the new instance. In the event of a hardware failure, the recovery unit forcibly restarts a power supply of a physical server using a management protocol. The system is applied to a use case such as automatic blocking of abnormal traffic due to a cyberattack or transition to independent operation of critical infrastructure in the event of a wide-area power outage. The system implements a self-healing capability of the system. The system minimizes downtime of the system without administrator intervention.

The user interface unit visualizes an operation status of the urban infrastructure, a transition of various sensor data, an AI analysis result, a content of optimization control, a failure occurrence history, an execution status of a restoration measure, feedback from residents, consistency with city planning, and the like for a system administrator and an operation manager, and enables an administrator to manually transmit a control command, adjust an analysis parameter of the AI, and set a priority of the restoration measure. For example, the user interface unit centrally displays a real-time traffic congestion map, a power consumption graph, an air quality heat map, a disaster occurrence status, an operation status of a communication network, and the like on a dashboard, and automatically issues a warning in the event of an abnormality. Specifically, the user interface unit is implemented as a single-page application based on a reactive programming architecture. The user interface unit asynchronously receives a data stream push-delivered from a server using a bidirectional communication protocol. The user interface unit binds the received data to a virtual document object model, and redraws only a difference of a screen at high speed. The user interface unit superimposes and displays a current value of each sensor and a prediction result of the AI on a three-dimensional model of a city using a particle effect and color mapping. When the administrator clicks a specific intersection object on the screen, the user interface unit pop-up displays chronological tensor data related to the intersection. The user interface unit signs an override command input by the administrator with a secure hash algorithm. The user interface unit transmits the signed command to the optimization control unit. The user interface unit visualizes an attention map indicating an inference basis of an AI model. The system provides explainability to a judgment process of the AI that is prone to becoming a black box. The system is applied to a use case such as top-down decision-making support in the event of a disaster by a mayor or a crisis management director, or a long-term infrastructure investment simulation by a city planning consultant. The system builds a relationship of trust between a human and a highly autonomous system. The system realizes intuitive governance of complex urban infrastructure.

As described above, in the embodiment of the present invention, the stratospheric communication platform, various sensors in the city, the data transmission unit, the database unit, the generative AI analysis unit, the optimization control unit, various urban infrastructure control units, the monitoring unit, the recovery unit, and the user interface unit closely cooperate, and realize integrated operation optimization of the urban infrastructure in real time and autonomously while maintaining safety, efficiency, sustainability, disaster response capability, and resident satisfaction of the entire city at a high level.

By utilizing the generative AI, dynamic, integrated, and predictive urban infrastructure management, which was impossible in conventional static and fragmented city operation, becomes possible, and wide-ranging social and economic values such as sustainable development of the city, improvement of quality of life of citizens, resilience enhancement in the event of a disaster, environmental load reduction, energy efficiency improvement, traffic congestion mitigation, health damage prevention, and city operation cost reduction are created. Specifically, the system models the entire city as a huge graph structure. The system defines each sensor and infrastructure facility as a node. The system defines a physical distance and a communication path as an edge. The system calculates an interaction between nodes using a graph neural network. The system represents data collected from each node as a multidimensional tensor. The system inputs this multidimensional tensor to the generative AI. The system adopts an ensemble architecture of a large language model and a time series prediction model as the generative AI. The system acquires, for example, a one-dimensional array indicating a traffic volume, a numerical vector indicating weather data, and a chronological matrix indicating a past infrastructure operation history as input data. The system normalizes these input data. The system maps the normalized data to a common latent space. The system extracts a hidden correlation between data using a self-attention mechanism. The system generates a numerical vector indicating an optimal operation parameter of each infrastructure facility as output data. The system calculates a score from zero to one indicating an abnormality occurrence probability as output data. The system determines whether or not this score exceeds a preset threshold. When the threshold is exceeded, the system transmits an emergency stop command to the corresponding infrastructure facility. By such a non-conventional processing method, the system detects a sign of a complex abnormality that cannot be discovered by human intuition or a simple rule base with high accuracy. As a result, the system dramatically improves calculation efficiency in the operation of the urban infrastructure. The system significantly reduces a load on the communication network. The system realizes real-time autonomous control in a specific application field such as traffic control and energy management of a smart city.

### System Configuration

The system according to the present embodiment includes a stratospheric communication platform unit, a sensor data collection unit, a data transmission unit, a database unit, a generative AI analysis unit, an optimization control unit, an urban infrastructure control unit, a monitoring unit, a recovery unit, and a user interface unit. A plurality of stratospheric communication platform units are arranged above a city, cover a wide area of the entire city, aggregate data from various sensors and IoT devices on the ground, and realize high-speed and stable bidirectional communication with a ground server. For example, optimal arrangement is made according to geographical characteristics of the city such as a city center, a suburb, an industrial area, a residential area, a port, an airport, a river basin, and a mountainous area, and a redundant configuration for preventing communication disruption even in the event of a disaster or an event is adopted. The sensor data collection unit has a function of acquiring data in real time from various sensors and IoT devices installed in various infrastructure areas such as traffic, energy, environment, disaster prevention, and communication in the city, and acquires, for example, the number of vehicles, a traffic volume by vehicle type, an average speed, a congestion level, a signal waiting time, accident occurrence information, a public transportation usage status, operation delay information of a bus or a railway, an availability status of a parking lot, and the like from a traffic sensor installed at a major intersection, a main road, a bus terminal, a railway station, a subway platform, an airport terminal, a port facility, and the like, an energy sensor is installed in a power plant, a substation, a switchboard, a building, a house, a factory, a commercial facility, a renewable energy power generation facility, and the like, and acquires power consumption, a power generation amount, a renewable energy ratio, a system voltage/current, an operation status of a power system, system failure occurrence information, a remaining storage battery level, peak power demand, and the like, an air quality sensor, a temperature/humidity sensor, a noise sensor, a dust sensor, a carbon dioxide sensor, a PM2.5 sensor, an odor sensor, an ultraviolet sensor, and the like are installed along a road, an industrial area, a residential area, a school, a hospital, a park, a tourist spot, and the like, and acquire environmental data such as a PM2.5 concentration, a carbon dioxide concentration, temperature, humidity, a noise level, odor detection, an ultraviolet amount, and a pollen scattering amount, a river water level gauge, a seismometer, a weather sensor, a landslide sensor, a fire alarm, a tsunami sensor, an evacuation shelter entry/exit sensor, and the like are installed in a river basin, a mountainous area, a coastal area, a city center, a residential area, a public facility, and the like, and acquire disaster prevention-related data such as a water level, a seismic waveform, a rainfall amount, a wind speed, a sediment runoff amount, fire occurrence information, a tsunami arrival prediction, and an evacuation shelter congestion status, and acquires an operation status of a communication device, a remaining battery level, failure occurrence information, a communication band usage rate, the number of terminal connections, communication delay, a packet loss rate, and the like from a communication base station, an IoT gateway, a Wi-Fi access point, an LPWA base station, a terminal device, and the like. The data transmission unit aggregates these vast amounts of sensor data to the ground server via the stratospheric communication platform, and performs advanced transmission control such as data compression, dynamic adjustment of a transmission interval according to a communication band and a network status, priority transmission according to importance, redundant path selection in the event of a disaster, data encryption/decryption, and retransmission control in the event of data loss. The database unit accumulates and manages all received data in chronological order, and integrally manages weather data, traffic data, energy data, environmental data, disaster prevention data, communication data for the past several years, urban infrastructure data and demographic data acquired from the outside, history data at the time of holding an event or occurrence of a disaster, a failure history for each device, city planning information, road construction information, an event schedule, a resident questionnaire result, and the like. The generative AI analysis unit has a function of predicting a situation change and an abnormality occurrence of the entire city with high accuracy using the vast amount of data accumulated in the database unit, and executing various optimization calculations, and for example, compares past traffic data with current traffic data, predicts and determines a traffic congestion occurrence risk for the next few hours to few days, an optimal signal control plan, a public transportation increase timing, a parking lot guidance plan, warning issuance of an accident-prone point, and the like, calculates a power saving request timing at the next peak, an activation condition of an emergency power supply, selection of a power accommodation destination, a charge/discharge plan of a storage battery, and the like from a past power consumption pattern, a renewable energy ratio, a current system load status, and weather prediction data for the energy data, derives an air pollution deterioration risk for the next 6 hours, a necessary traffic restriction measure, a factory operation suppression plan, a transmission timing of a health damage warning to residents, and the like from chronological data of the air quality sensor, weather data, traffic volume data, and factory operation data for the environmental data, determines an emergency warning issuance timing in the event of a disaster, optimization of an evacuation guidance route, a congestion mitigation measure for an evacuation shelter, a relief supply delivery plan, and the like from an abnormal value of the seismometer or the river water level gauge, warning data of the Japan Meteorological Agency, SNS post data, and the like for the disaster prevention data, and optimizes a switching condition to a backup communication path, allocation of a priority communication band, a network load distribution plan, an automatic restoration procedure in the event of a failure, and the like from the remaining battery level of the communication device, the failure occurrence history, the number of terminal connections, the communication band usage rate, and network topology information for the communication data. The optimization control unit automatically transmits a specific control command to each urban infrastructure control unit such as a traffic signal control system, a public transportation operation management system, a power system control system, an environmental regulation system, a disaster prevention information distribution system, and a communication network control system based on an analysis result of the generative AI analysis unit, and for example, when traffic congestion is predicted during morning and evening rush hours, dynamically changes a signal control timing, instructs a public transportation increase, reflects an availability status in a parking lot guidance system, when power consumption reaches a peak and a power system is overloaded, determines a power saving request, priority use of renewable energy, activation of an emergency power supply, charge/discharge switching of a storage battery, and a peak cut instruction to a factory or a large commercial facility, when air pollution exceeds a reference value, automatically executes a traffic restriction in a specific area, factory operation suppression, warning issuance to residents, and an air purifier operation instruction to a school or a hospital, when a disaster such as an earthquake, a flood, or a rainstorm is detected, immediately executes emergency warning issuance, evacuation guidance, priority power supply to critical infrastructure, redundancy of a communication network, optimization of a relief supply delivery route, a congestion mitigation measure for an evacuation shelter, and the like, and when a failure or a battery drop occurs in a communication device, instructs switching to a backup communication path, priority band allocation to important communication, reconfiguration of a network topology, and automatic detection and notification of a failure occurrence location, and ensures communication continuation of the entire city. The monitoring unit monitors an operation status of the entire system in real time, detects a sign of an abnormality or a failure early, detects various abnormality patterns, for example, when a value of sensor data exceeds a threshold, when communication traffic rapidly increases, when a device temperature abnormally rises, when a remaining battery level rapidly drops, or when there is an abnormality report by a complaint from a resident or an SNS post, and notifies an administrator and the AI analysis unit. The recovery unit rapidly and autonomously executes a restoration measure based on information from the generative AI analysis unit and the monitoring unit in the event of a failure or a disaster, ensures continuation of a communication service and urban infrastructure, for example, automatically selects a redundant communication path and ensures the continuation of the communication service when some devices of the communication platform fail, temporarily stops a device with high power consumption and maintains only an important communication function when the remaining battery level rapidly drops, preferentially allocates a band to communication with high priority and temporarily restricts communication of a general user in the event of a disaster, and automatically transmits a notification prompting residents to perform distributed evacuation when congestion of an evacuation shelter is predicted. The user interface unit visualizes an operation status of the urban infrastructure, a transition of various sensor data, an AI analysis result, a content of optimization control, a failure occurrence history, an execution status of a restoration measure, feedback from residents, consistency with city planning, and the like for a system administrator and an operation manager, enables an administrator to manually transmit a control command, adjust an analysis parameter of the AI, and set a priority of the restoration measure, for example, centrally displays a real-time traffic congestion map, a power consumption graph, an air quality heat map, a disaster occurrence status, an operation status of a communication network, and the like on a dashboard, and automatically issues a warning in the event of an abnormality. Specific examples of a prompt sentence to be read into the generative AI necessary for implementing the present invention include “Present a congestion occurrence risk for the next 2 hours and an optimal signal control plan from traffic data for the past 1 month and a current traffic status”, “Propose a power saving request timing at the next peak and an activation condition of an emergency power supply from a past load transition of a power system and a renewable energy ratio”, “Calculate an air pollution deterioration risk for the next 6 hours and a necessary traffic restriction measure from chronological data of an air quality sensor and weather data”, “Determine an optimal timing of emergency warning issuance and evacuation guidance in the event of a disaster from an abnormal value of a seismometer or a river water level gauge”, and “Optimize a switching condition to a backup communication path and allocation of a priority communication band from a remaining battery level of a communication device and a failure occurrence history”. Specifically, the system includes a plurality of graphics processing units having advanced parallel computing capability. The system executes learning and inference of a large-scale neural network using these computing units. The system converts an analog signal into a digital signal in the sensor data collection unit. The system acquires the digitized data at a constant sampling rate. The system stores the acquired data in a memory as an array of floating-point numbers. The system packetizes these array data in the data transmission unit. The system adds a time stamp and position information to a header of a packet. The system stores the received packet in a time series database in the database unit. The system executes a deep learning model based on a transformer architecture in the generative AI analysis unit. The system acquires, for example, a 24-dimensional numerical vector indicating a traffic volume for the past 24 hours, a two-dimensional numerical vector indicating temperature and humidity, and a chronological array indicating a usage rate of a communication band as input data. The system combines these input data to generate one input tensor. The system supplies the input tensor to an input layer of the deep learning model. The system applies a nonlinear activation function in a hidden layer. The system generates a score indicating a traffic congestion probability for the next 1 hour, a scalar value indicating a predicted value of power demand, and a categorical label indicating an optimal communication path as output data. The system receives these output data in the optimization control unit. The system generates a control command based on the output data. For example, when the score of the traffic congestion probability exceeds 0.8, the system generates a control command to extend a green lighting time of a traffic signal. The system transmits this control command to the corresponding traffic signal control system. By such processing, the system computes a vast amount of sensor data at high speed in a high-dimensional space. The system realizes fully automatic infrastructure control excluding human intervention. As a result, the system minimizes a delay in data processing. The system dramatically improves a response speed of the entire system. The system functions extremely effectively in a use case such as evacuation guidance in the event of a disaster or crowd control at the time of a large-scale event.

### Implementation Steps

Step 1: Sensor Data Collection from Entire City The stratospheric communication platform unit and the sensor data collection unit acquire data in real time from various sensors and IoT devices installed in various infrastructure areas such as traffic, energy, environment, disaster prevention, and communication in the city. For example, the number of vehicles, a traffic volume by vehicle type, an average speed, a congestion level, a signal waiting time, accident occurrence information, a public transportation usage status, operation delay information of a bus or a railway, an availability status of a parking lot, and the like are acquired from a traffic sensor installed at a major intersection, a main road, a bus terminal, a railway station, a subway platform, an airport terminal, a port facility, and the like, an energy sensor is installed in a power plant, a substation, a switchboard, a building, a house, a factory, a commercial facility, a renewable energy power generation facility, and the like, and acquires power consumption, a power generation amount, a renewable energy ratio, a system voltage/current, an operation status of a power system, system failure occurrence information, a remaining storage battery level, peak power demand, and the like, an air quality sensor, a temperature/humidity sensor, a noise sensor, a dust sensor, a carbon dioxide sensor, a PM2.5 sensor, an odor sensor, an ultraviolet sensor, and the like are installed along a road, an industrial area, a residential area, a school, a hospital, a park, a tourist spot, and the like, and acquire environmental data such as a PM2.5 concentration, a carbon dioxide concentration, temperature, humidity, a noise level, odor detection, an ultraviolet amount, and a pollen scattering amount, a river water level gauge, a seismometer, a weather sensor, a landslide sensor, a fire alarm, a tsunami sensor, an evacuation shelter entry/exit sensor, and the like are installed in a river basin, a mountainous area, a coastal area, a city center, a residential area, a public facility, and the like, and acquire disaster prevention-related data such as a water level, a seismic waveform, a rainfall amount, a wind speed, a sediment runoff amount, fire occurrence information, a tsunami arrival prediction, and an evacuation shelter congestion status, and an operation status of a communication device, a remaining battery level, failure occurrence information, a communication band usage rate, the number of terminal connections, communication delay, a packet loss rate, and the like are acquired from a communication base station, an IoT gateway, a Wi-Fi access point, an LPWA base station, a terminal device, and the like. Specifically, the system executes initial data processing in each edge device. The system applies a low-pass filter to raw data acquired from a sensor. The system removes high-frequency noise. The system standardizes the data after noise removal to have zero mean and unit variance. The system packs the standardized data into a multidimensional tensor format. The system generates, for example, a three-dimensional numerical vector including a passing time, a vehicle speed, and a vehicle length of a vehicle as input data from the traffic sensor. The system generates a three-dimensional numerical vector including active power, reactive power, and a power factor as input data from the energy sensor. The system generates a five-dimensional numerical vector indicating a concentration of various gases as input data from the environmental sensor. The system aggregates these vector data for each constant time window. The system temporarily stores the aggregated data in a memory buffer as a batch processing unit. The system sets a transmission flag when a data amount in the memory buffer reaches a specified value. The system activates a data transmission module using this transmission flag as a trigger. By such preprocessing on the edge side, the system significantly reduces a data amount to be transmitted to a central server. The system prevents depletion of a communication band in advance. As a result, the system reduces a communication load of the entire network. The system dramatically improves scalability in a use case of integrally managing millions of Internet of Things devices distributed over a wide area.
Step 2: Data Transmission and Chronological Accumulation The data transmission unit aggregates the vast amount of sensor data collected from the entire city via the stratospheric communication platform to the ground server, and performs advanced transmission control such as data compression, dynamic adjustment of a transmission interval according to a communication band and a network status, priority transmission according to importance, redundant path selection in the event of a disaster, data encryption/decryption, and retransmission control in the event of data loss. The database unit accumulates and manages all received data in chronological order, and integrally manages weather data, traffic data, energy data, environmental data, disaster prevention data, communication data for the past several years, urban infrastructure data and demographic data acquired from the outside, history data at the time of holding an event or occurrence of a disaster, a failure history for each device, city planning information, road construction information, an event schedule, a resident questionnaire result, and the like. Specifically, the system applies a variable-length coding algorithm in the data transmission unit. The system dynamically determines an optimal compression rate based on information entropy of transmission data. The system adds an error correction code to a compressed data stream. The system executes spatial diversity communication using a plurality of antennas of the stratospheric communication platform. The system receives the data stream at a network interface of the ground server. The system decodes the received data stream. The system writes the decoded data to a distributed in-memory database. The system adds a spatial index and a temporal index to each data record in the database unit. The system manages the index using a B-tree structure. Thereby, the system shortens an execution speed of a search query for a vast amount of petabyte-class chronological data to milliseconds. The system generates a view that seamlessly combines past history data and real-time stream data. The system provides this view to the subsequent generative AI analysis unit. By such an advanced data management method, the system maximizes utilization efficiency of a storage. The system eliminates an input/output bottleneck associated with reading and writing of data. The system realizes data provision with extremely low latency in a use case such as instantaneous balancing of power supply and demand in a smart grid or real-time road surface condition distribution to an autonomous driving vehicle.
Step 3: Integrated Analysis and Prediction by Generative AI The generative AI analysis unit predicts a situation change and an abnormality occurrence of the entire city with high accuracy using the vast amount of data accumulated in the database unit, and executes various optimization calculations. For example, the generative AI analysis unit compares past traffic data with current traffic data, predicts and determines a traffic congestion occurrence risk for the next few hours to few days, an optimal signal control plan, a public transportation increase timing, a parking lot guidance plan, warning issuance of an accident-prone point, and the like, calculates a power saving request timing at the next peak, an activation condition of an emergency power supply, selection of a power accommodation destination, a charge/discharge plan of a storage battery, and the like from a past power consumption pattern, a renewable energy ratio, a current system load status, and weather prediction data for the energy data, derives an air pollution deterioration risk for the next 6 hours, a necessary traffic restriction measure, a factory operation suppression plan, a transmission timing of a health damage warning to residents, and the like from chronological data of the air quality sensor, weather data, traffic volume data, and factory operation data for the environmental data, determines an emergency warning issuance timing in the event of a disaster, optimization of an evacuation guidance route, a congestion mitigation measure for an evacuation shelter, a relief supply delivery plan, and the like from an abnormal value of the seismometer or the river water level gauge, warning data of the Japan Meteorological Agency, SNS post data, and the like for the disaster prevention data, and optimizes a switching condition to a backup communication path, allocation of a priority communication band, a network load distribution plan, an automatic restoration procedure in the event of a failure, and the like from the remaining battery level of the communication device, the failure occurrence history, the number of terminal connections, the communication band usage rate, and network topology information for the communication data. Specific examples of a prompt sentence to be read into the generative AI include “Present a congestion occurrence risk for the next 2 hours and an optimal signal control plan from traffic data for the past 1 month and a current traffic status”, “Propose a power saving request timing at the next peak and an activation condition of an emergency power supply from a past load transition of a power system and a renewable energy ratio”,

“Calculate an air pollution deterioration risk for the next 6 hours and a necessary traffic restriction measure from chronological data of an air quality sensor and weather data”, “Determine an optimal timing of emergency warning issuance and evacuation guidance in the event of a disaster from an abnormal value of a seismometer or a river water level gauge”, and “Optimize a switching condition to a backup communication path and allocation of a priority communication band from a remaining battery level of a communication device and a failure occurrence history”. Specifically, the system executes a hybrid architecture integrating a natural language processing model and a graph convolutional network in the generative AI analysis unit. The system inputs the prompt sentence to a tokenizer. The system converts the prompt sentence into a sequence of integers. The system inputs this sequence to an embedding layer to generate a high-dimensional word vector. At the same time, the system extracts chronological sensor data acquired from the database unit as a numerical matrix. The system combines the word vector and the numerical matrix to construct a multimodal input tensor. The system acquires, for example, a 100-dimensional vector representing the number of vehicles for each intersection for the past 1 hour and a one-hot encoding vector of a categorical variable representing a weather condition as input data. The system inputs these input tensors to a multi-layer transformer block. The system calculates a multi-head attention mechanism in each block. The system outputs a continuous value score from zero to one indicating a congestion occurrence probability for the next 15 minutes at each intersection as output data. The system outputs an integer value indicating a recommended cycle length of a traffic signal as output data. The system generates an output vector of a softmax function indicating a failure probability distribution in a specific infrastructure facility as output data. The system pushes these output results to an input queue of the optimization control unit. By such multimodal learning, the system evaluates data of heterogeneous formats in the same latent space. The system dramatically improves prediction accuracy compared to a conventional prediction model based on a single data source. The system autonomously supports optimal decision-making in a use case such as prediction of a complex disaster in a complex urban environment or dynamic resource allocation at the time of a large-scale event.
Step 4: Automatic transmission of optimization control command An optimization control unit automatically transmits a specific control command to each urban infrastructure control unit such as a traffic signal control system, a public transportation operation management system, a power system control system, an environmental regulation system, a disaster prevention information distribution system, and a communication network control system based on an analysis result of a generative AI analysis unit. For example, when traffic congestion is predicted during morning and evening rush hours, the optimization control unit dynamically changes signal control timing, instructs an increase in public transportation, and reflects availability in a parking lot guidance system; when power consumption reaches a peak and a system is overloaded, determines a power saving request, priority use of renewable energy, activation of an emergency power supply, charge/discharge switching of a storage battery, and a peak cut instruction to a factory or a large commercial facility; when air pollution exceeds a reference value, automatically implements traffic restriction in a specific area, factory operation suppression, warning issuance to residents, and an air purifier operation instruction to a school or a hospital; when a disaster such as an earthquake, a flood, or a rainstorm is detected, immediately executes issuance of an emergency warning, evacuation guidance, priority power supply to an important infrastructure, redundancy of a communication network, optimization of a relief supply delivery route, a congestion mitigation measure for an evacuation shelter, and the like; and when a failure or a battery drop occurs in a communication device, instructs switching to a backup communication path, priority band allocation to important communication, reconfiguration of a network topology, and automatic detection and notification of a failure occurrence location, and ensures communication continuity of the entire city. Specifically, the system receives a probability distribution and a score output from the generative AI analysis unit in the optimization control unit. The system performs a comparison operation between the received score and a plurality of threshold parameters retained in a memory. For example, when a score of a congestion occurrence probability exceeds a first threshold, the system activates a signal control algorithm. The system calculates a duration of a green light at a target intersection by this algorithm. The system generates a control packet including the calculated time in a payload. The system transmits this control packet to a local traffic signal control system via a secure communication tunnel. When an overload probability of the power system exceeds a second threshold, the system generates a command vector instructing a smart meter to limit power consumption. The system simultaneously transmits this command vector using a multicast protocol. When a failure probability of the communication device exceeds a third threshold, the system automatically generates an update script for a routing table. The system distributes this script to each router and immediately establishes a detour route for traffic. The system records a transmission history of these control commands in a storage as a log file. The system utilizes this log file as retraining data for a next AI model. By constructing such a closed-loop control system, the system completely eliminates manual intervention by a human operator. The system reduces a control delay to a millisecond order. The system optimizes an infrastructure operation rate of the entire city and significantly reduces energy consumption. The system minimizes damage in a use case such as automatic operation of an inland water flood prevention pump during a sudden guerrilla rainstorm or transition to a microgrid autonomous operation during a large-scale power outage.
Step 5: Monitoring of system operation status and failure response A monitoring unit monitors an operation status of the entire system in real time, detects a sign of an abnormality or a failure at an early stage, detects various abnormality patterns, for example, when a value of sensor data exceeds a threshold, when communication traffic rapidly increases, when a device temperature abnormally rises, when a remaining battery level rapidly drops, or when there is an abnormality report by a complaint from a resident or an SNS post, and notifies an administrator or the AI analysis unit. A recovery unit quickly and autonomously executes a restoration measure based on information from the generative AI analysis unit or the monitoring unit in the event of a failure or a disaster, ensures continuation of a communication service or an urban infrastructure, for example, automatically selects a redundant communication path to ensure continuation of the communication service when some devices of a communication platform fail, temporarily stops a device with high power consumption to maintain only an important communication function when the remaining battery level rapidly drops, preferentially allocates a band to communication with high priority and temporarily restricts communication of a general user in the event of a disaster, and automatically transmits a notification prompting residents to perform distributed evacuation when congestion of an evacuation shelter is predicted. Specifically, the system constantly monitors an operation log and a sensor data stream of the entire system in the monitoring unit. The system inputs the monitored data stream to an autoencoder-type anomaly detection neural network. The system acquires, as input data, a multidimensional time-series vector including, for example, a CPU usage rate of each server, a memory consumption amount, and a packet drop rate of a network interface. The system compresses this input vector into a low-dimensional latent variable. The system reconstructs the original multidimensional time-series vector from the latent variable. The system calculates a mean square error between the input vector and the reconstructed vector. The system outputs this mean square error as an anomaly score as output data. When the anomaly score exceeds a dynamically set threshold, the system determines that a hardware or software abnormality has occurred. The system transmits an abnormality determination signal to the recovery unit. In the recovery unit, the system immediately starts a failover process upon receiving the abnormality signal. The system restarts a process of a node where the failure has occurred on a standby node using a snapshot of a virtual machine. The system rewrites a setting of a load balancer and redirects traffic to a normal node. The system transmits a transition command to a sleep mode to a communication device whose remaining battery level has dropped. By such an autonomous self-healing mechanism, the system brings a system downtime close to zero to the utmost limit. The system prevents an influence of a single point of failure from spreading to the entire system. The system provides extremely high availability and fault tolerance in a use case such as maintenance of a mission-critical financial transaction network or securing of an emergency communication network in the event of a wide-area disaster.
Step 6: Operation management and visualization by user interface A user interface unit visualizes an operation status of an urban infrastructure, a transition of various sensor data, an AI analysis result, content of optimization control, a failure occurrence history, an execution status of a restoration measure, feedback from a resident, consistency with an urban plan, and the like for a system administrator or an operation person in charge, enables the administrator to manually transmit a control command, adjust an analysis parameter of the AI, or set a priority of the restoration measure, centrally displays, for example, a real-time traffic congestion map, a power consumption graph, an air quality heat map, a disaster occurrence status, an operation status of a communication network, and the like on a dashboard, and automatically issues a warning when an abnormality occurs. Specifically, the system executes a web-based dashboard application in the user interface unit. The system receives a real-time data stream from a back-end server via WebSocket communication. The system passes the received data to a front-end rendering engine. The system overlays and displays various sensor data on a three-dimensional model of the city using the rendering engine. For example, the system maps a degree of traffic congestion on a polygon as a color gradation from red to green. The system draws a transition of power consumption as a dynamic line graph. When the administrator clicks a specific infrastructure facility on a screen, the system displays a detailed operation parameter of the corresponding facility and a prediction score by the AI in a pop-up window. The system provides an input form for the administrator to manually change a parameter. The system converts a change value input by the administrator into a payload in a JSON format. The system transmits this payload to the optimization control unit via a RESTful application programming interface. The system records an operation history and feedback of the administrator as a reward function of a reinforcement learning model. The system fine-tunes a parameter of the generative AI using this reward signal. By such an intuitive and interactive visualization technology, the system converts a vast amount of complex urban data into a format that can be easily understood by a human. The system strongly supports a decision-making process of the administrator. The system constructs a human-in-the-loop machine learning pipeline and continuously improves prediction accuracy of the system. The system enables data-driven policy making in a use case such as simulation of an urban plan or arrangement optimization of a new infrastructure facility.

### Specific Use Case

For example, a case where a large-scale sports event is held in a city center is assumed. In this case, a stratospheric communication platform unit covers the entire city, and acquires, in real time, the number of vehicles, a traffic volume by vehicle type, an average speed, a congestion level, a signal waiting time, accident occurrence information, a public transportation usage status, operation delay information of a bus or a railway, availability of a parking lot, and the like from a traffic sensor installed at a major intersection, an arterial road, a bus terminal, a railway station, a subway platform, an airport terminal, around an event venue, a parking lot, and the like. Furthermore, power consumption, a power generation amount, a renewable energy ratio, a system voltage/current, an operation status of a power system, system failure occurrence information, a remaining storage battery level, peak power demand, and the like are acquired from an energy sensor installed at the event venue or a surrounding power plant, substation, commercial facility, temporary power supply facility, and the like. In addition, environmental data such as a PM2.5 concentration, a carbon dioxide concentration, a temperature, a humidity, a noise level, bad odor detection, and an ultraviolet amount is acquired from an air quality sensor, a temperature/humidity sensor, a noise sensor, a PM2.5 sensor, and the like installed around the venue, along a major road, in a residential area, a school, a hospital, a park, and the like, and disaster prevention-related data such as a water level, a seismic waveform, a rainfall amount, a wind speed, fire occurrence information, and an evacuation shelter congestion status is acquired from a river water level gauge, a seismometer, a weather sensor, a fire alarm, an evacuation shelter entry/exit sensor, and the like. Furthermore, an operation status of a communication device, a remaining battery level, failure occurrence information, a communication band usage rate, the number of terminal connections, a communication delay, a packet loss rate, and the like are acquired from a communication base station, an IoT gateway, a Wi-Fi access point, a terminal device, and the like at or around the event venue. Specifically, when an event is held, the system shifts to a mode of collecting data at a high frequency from tens of thousands of sensor devices existing in a specific geographical area. The system multicasts a control command to increase a sampling rate of each sensor device to ten times a normal rate. The system acquires, as input data from the traffic sensor, a one-dimensional array indicating the number of passing vehicles for each intersection and a two-dimensional tensor indicating a movement vector of a pedestrian. The system acquires, as input data from the energy sensor, an array of floating-point numbers indicating instantaneous power consumption in each sector of a stadium. The system acquires, as input data from the environmental sensor, a heat map image tensor indicating a temperature distribution of audience seats. The system acquires, as input data from the communication device, matrix data indicating the number of connected terminals and a radio wave intensity for each base station. The system combines these various input data into a single huge multidimensional tensor using a time stamp as a key. The system maps the combined tensor to a shared memory space. The system transfers this tensor to a video memory of a graphics processing unit at high speed using direct memory access transfer. By such dynamic switching of the data collection mode, the system captures a rapid environmental change during the event with a resolution in milliseconds. The system prevents data loss or delay, and provides a necessary and sufficient information amount for subsequent AI analysis. As a result, the system stably operates the system even against an explosive increase in local data traffic. The system exhibits an overwhelming monitoring capability in a use case such as securing safety of a crowd in an ultra-large-scale event such as the Olympics or the World Cup, or preventing terrorism.

The generative AI analysis unit uses these vast amounts of data to cause the generative AI to read a prompt sentence such as, for example, “Present a congestion occurrence risk for the next 3 hours and an optimal signal control plan from past traffic data and a current traffic situation when an event is held”, “Propose a power saving request timing and an activation condition of an emergency power supply at a next peak from a past load transition of a power system around an event venue and a renewable energy ratio”, “Calculate an air pollution deterioration risk for the next 6 hours and a necessary traffic restriction measure from time-series data of an air quality sensor around a venue and weather data”, “Optimize a switching condition to a backup communication path and allocation of a priority communication band from a remaining battery level of a communication device and a failure occurrence history during an event period”, or “Determine an optimal timing of emergency warning issuance and evacuation guidance in the event of a disaster from disaster prevention sensor data around an event venue”, and performs integrated analysis and prediction. Specifically, the system executes a prompt generation module in the generative AI analysis unit. The system dynamically synthesizes an optimal prompt sentence based on a statistic of the collected multidimensional tensor. The system inputs the synthesized prompt sentence to a context window of a large language model. At the same time, the system inputs the multidimensional tensor to a feature amount extraction network and converts it into a fixed-length context vector. The system injects this context vector into a cross-attention layer of the large language model. The system acquires, as input data, for example, a time-series vector indicating a traffic volume transition around the stadium for the past three hours and a categorical vector indicating current weather data. The system autoregressively generates a token in a decoder layer of the large language model. The system generates, as output data, an array of floating-point numbers indicating a congestion probability in each road segment for the next three hours. The system generates, as output data, a list of integer values indicating an optimal cycle length of a traffic signal. The system calculates, as output data, a percentage score from zero to one hundred indicating an overload risk of the power system. The system generates, as output data, a node ID sequence of a recommended evacuation route. The system formats these output data as a structured JSON object. By such multimodal prompt processing, the system fuses flexibility of a natural language and strictness of numerical data. The system discovers an optimal solution satisfying a complex constraint condition from a vast search space at high speed. As a result, the system dramatically enhances an adaptation capability of the system to an unpredictable situation during the event. The system provides advanced inference directly linked to lifesaving in a use case such as suppression support of a sudden riot or immediate calculation of an optimal transportation route for a suddenly ill person.

Based on the analysis result, the optimization control unit dynamically changes signal control timing around the event venue, instructs an increase in public transportation or temporary bus operation, and reflects availability in the parking lot guidance system, for example. When power consumption reaches a peak and the system is overloaded, the optimization control unit determines a power saving request, priority use of renewable energy, activation of an emergency power supply, charge/discharge switching of a storage battery, and a peak cut instruction to a commercial facility. When air pollution exceeds a reference value, the optimization control unit automatically implements traffic restriction in a specific area, factory operation suppression, warning issuance to residents, and an air purifier operation instruction to a school or a hospital. When a disaster is detected, the optimization control unit immediately executes issuance of an emergency warning, evacuation guidance, priority power supply to an important infrastructure, redundancy of a communication network, optimization of a relief supply delivery route, a congestion mitigation measure for an evacuation shelter, and the like. When a failure or a battery drop occurs in a communication device, the optimization control unit instructs switching to a backup communication path, priority band allocation to important communication, reconfiguration of a network topology, and automatic detection and notification of a failure occurrence location, and ensures communication continuity of the entire city. Specifically, the system parses the JSON object output from the generative AI analysis unit in the optimization control unit. The system extracts various control scores and parameters from the parsed data. The system evaluates the extracted array of congestion probabilities. When a congestion probability of a specific road segment exceeds a specified threshold, the system transmits an extension command of a green light to a control controller of a traffic signal connected to the corresponding segment. When an overload risk score of the power system exceeds eighty percent, the system transmits a peak cut command to reduce an output of an air conditioning facility by twenty percent to a smart meter installed in a commercial facility around the stadium. When a predicted value of air pollution exceeds an environmental standard, the system distributes image data warning of vehicle entry prohibition to a surrounding digital signage. When a failure detection flag of the communication device is true, the system issues an update command of a flow rule using an OpenFlow protocol to a controller of a software-defined network. The system immediately establishes a new communication path bypassing a failure location by this update command. The system enqueues these control commands in an asynchronous messaging queue. The system dequeues the commands from the queue using a plurality of worker processes, and transmits them in parallel to each infrastructure facility. By such parallel distributed processing, the system simultaneously applies control commands to tens of thousands of devices with a delay of a millisecond order. The system synchronizes a physical operation of the urban infrastructure with an execution speed of software. As a result, the system smoothes a rapid load fluctuation during the event and completely prevents paralysis of an urban function. The system provides an extremely scalable control infrastructure in a use case such as dynamic balancing of a smart grid or group control of an autonomous vehicle.

In such a use case, specific examples of the prompt sentence to be read by the generative AI include “Present a congestion occurrence risk for the next 3 hours and an optimal signal control plan from past traffic data and a current traffic situation when an event is held”, “Propose a power saving request timing and an activation condition of an emergency power supply at a next peak from a past load transition of a power system around an event venue and a renewable energy ratio”, “Calculate an air pollution deterioration risk for the next 6 hours and a necessary traffic restriction measure from time-series data of an air quality sensor around a venue and weather data”, “Optimize a switching condition to a backup communication path and allocation of a priority communication band from a remaining battery level of a communication device and a failure occurrence history during an event period”, and “Determine an optimal timing of emergency warning issuance and evacuation guidance in the event of a disaster from disaster prevention sensor data around an event venue”. Specifically, the system utilizes a template engine in a generation process of the prompt sentence. The system dynamically embeds latest sensor data or a statistical value acquired from a database unit into a placeholder of a template. The system acquires, as input data, for example, a numerical value indicating a current remaining battery level, a time-series array indicating a packet loss rate for the past twenty-four hours, and an adjacency matrix indicating a network topology. The system serializes these input data into a character string format. The system combines the serialized data into a context section of the prompt sentence. The system transmits the completed prompt sentence to an inference endpoint of the large language model. The system calculates a dependency relationship between each token in the prompt using a self-attention mechanism of a transformer architecture inside the large language model. The system generates, as output data, a list indicating a candidate for a backup communication path, a reliability score of each candidate, and a set of percentage values indicating an allocation ratio of a priority communication band. The system returns this information in a structured data format as output data. The system passes the returned data set to a subsequent network control module. The system automatically selects a path with the highest reliability score and updates a routing table in the network control module. By such dynamic prompt generation and structured output analysis, the system causes the large language model to function not merely as a dialogue system but as a core engine of autonomous system control. The system infers and executes an optimal countermeasure from past learning data even for an unknown failure pattern that cannot be handled by a rule-based system. As a result, the system dramatically improves a self-healing capability of the system. The system dramatically enhances toughness of a communication infrastructure in a use case such as autonomous path restoration at the time of network division due to a cyber attack or automatic construction of an ad hoc network in the event of a large-scale disaster.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL:https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

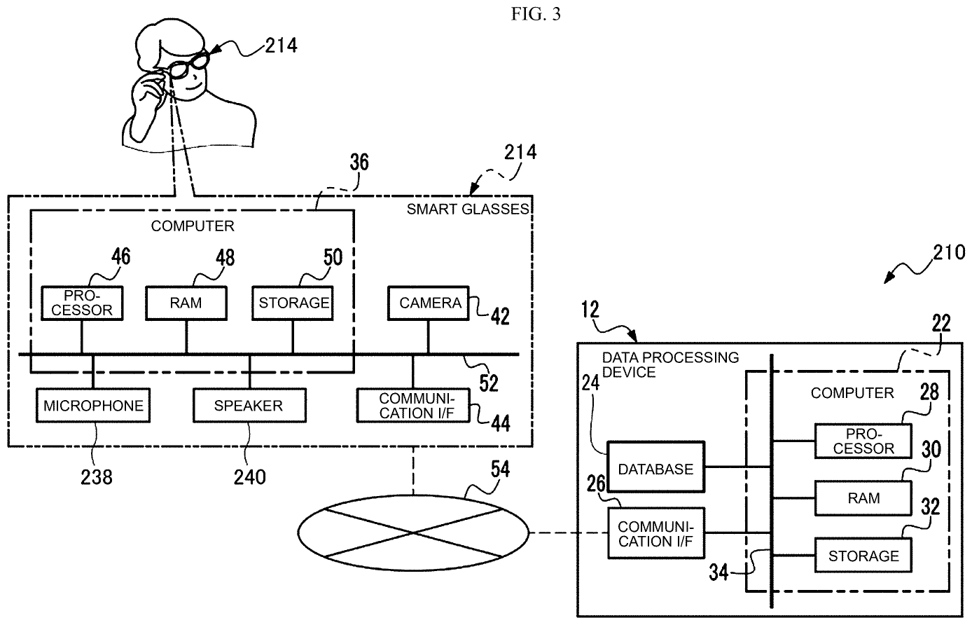

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

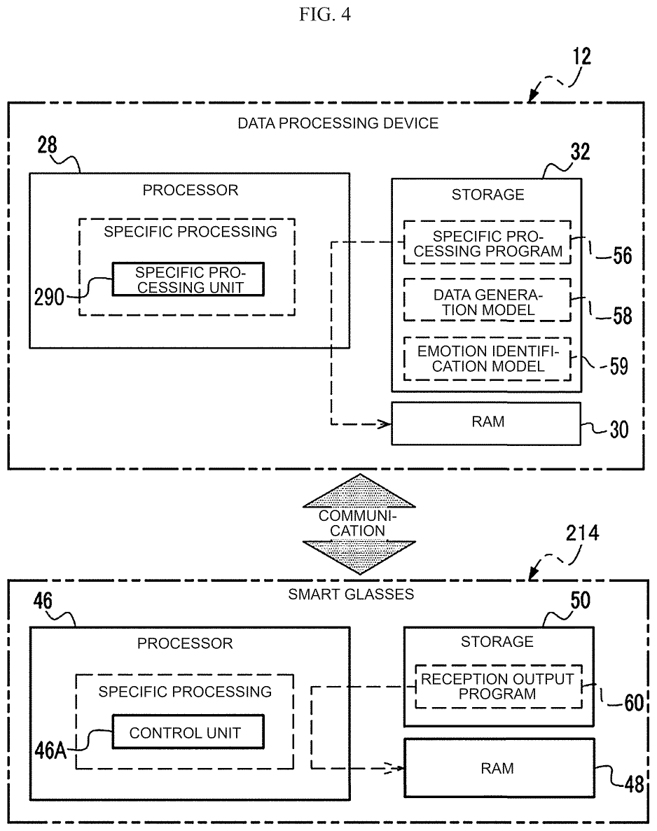

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

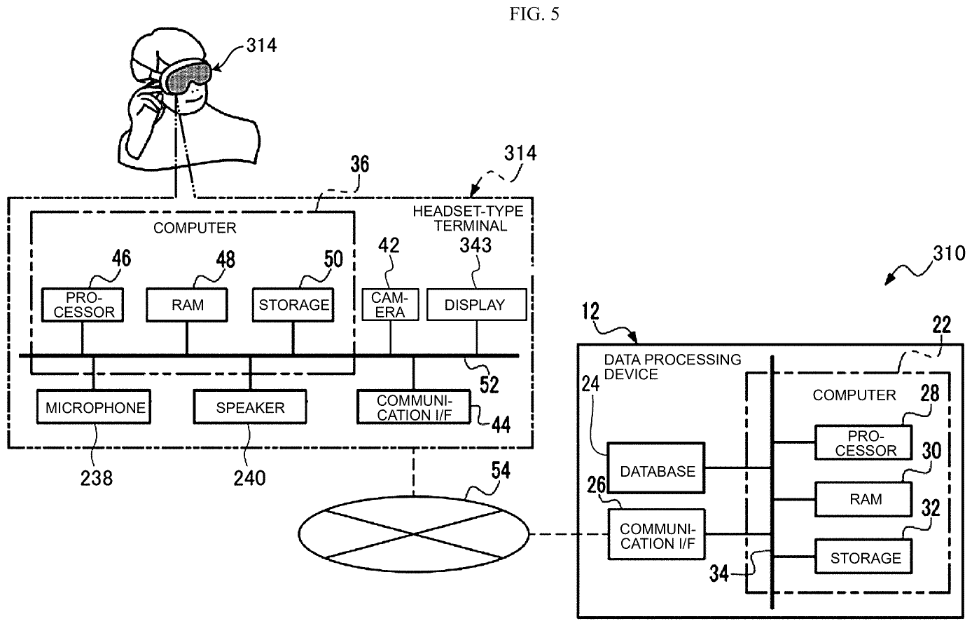

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

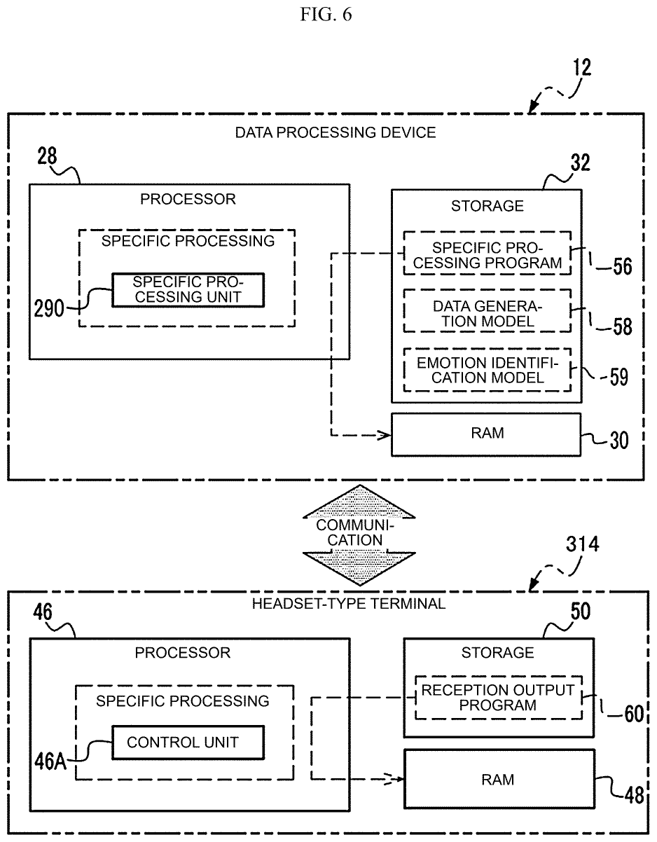

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

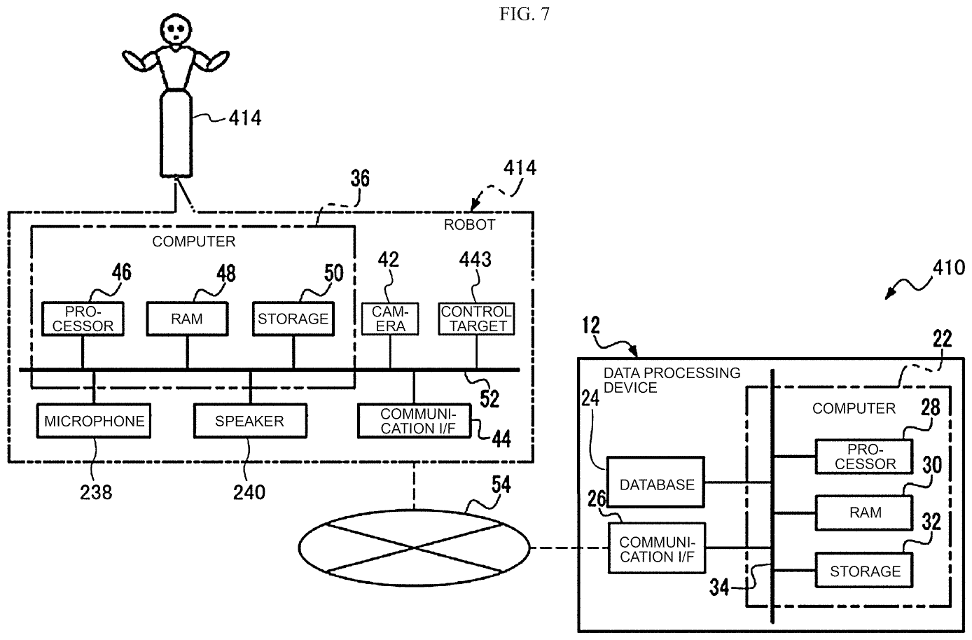

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

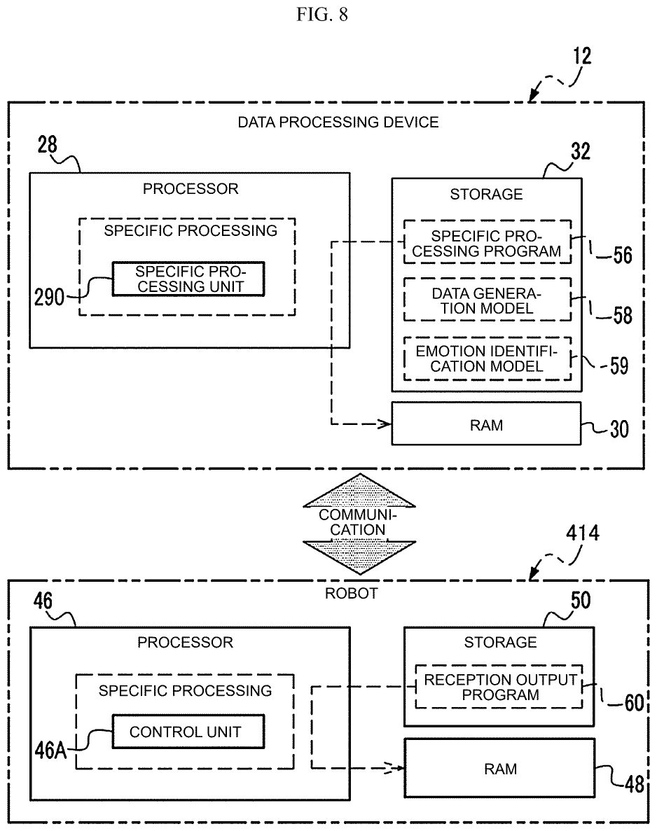

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

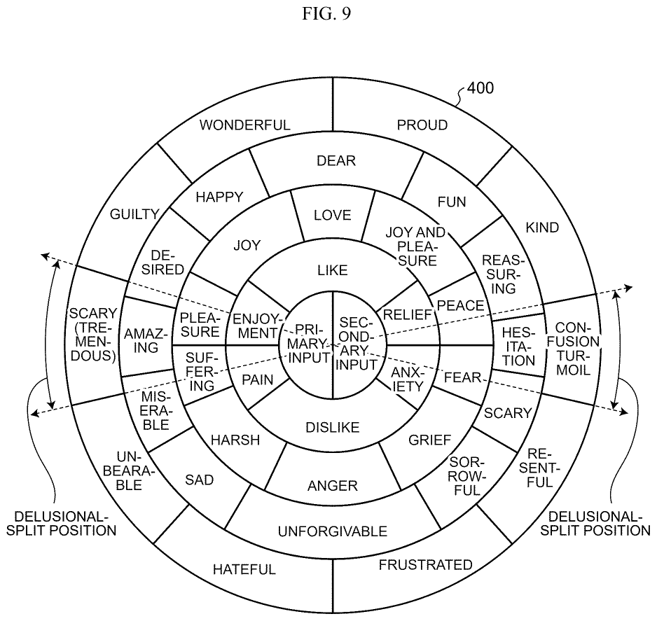

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

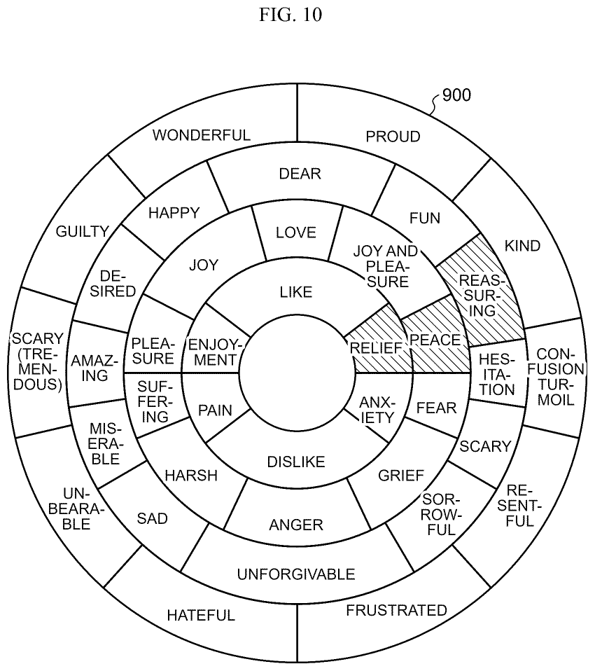

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

An integrated urban infrastructure optimization system comprising: a sensor data collection unit configured to collect, in real time, a plurality of sensor data relating to traffic, energy, environment, disaster prevention, and communication in a city; an analysis unit configured to aggregate the data acquired from the sensor data collection unit to a server via a stratospheric communication platform, integrally and chronologically analyze various urban infrastructure data such as traffic conditions, energy consumption, environmental indicators, disaster prevention risks, and communication device states using a generative AI on the server, and predict a situation change and an abnormality occurrence of the entire city with high accuracy; and an optimization control unit configured to autonomously and dynamically transmit an optimal control command to each urban infrastructure sector such as traffic signal control, public transportation operation management, power system control, environmental regulation, disaster prevention information distribution, and communication network control based on an analysis result of the analysis unit, and maintain safety, efficiency, sustainability, and disaster response capability of the entire city at a high level, wherein the analysis unit and the optimization control unit operate with the generative AI as an essential component, and realize integrated operation optimization of the urban infrastructure in real time.

### Supplementary Note 2

The system according to Supplementary Note 1, wherein the generative AI retains a vast amount of chronological data collected from a traffic sensor, an energy sensor, an environmental sensor, a disaster prevention sensor, a communication device sensor, and the like as a long-term memory, predicts future risks and demand fluctuations such as traffic congestion, power system overload, air pollution, disaster occurrence, and communication failure in the city with high accuracy while learning past patterns and abnormality occurrence histories, and autonomously optimizes the control command to each infrastructure sector based on a prediction result.

### Supplementary Note 3

The system according to Supplementary Note 1, wherein the optimization control unit autonomously executes, in real time, signal control and public transportation increase in the event of traffic congestion, a power saving request and priority use of renewable energy in the event of power system overload, traffic restriction and factory operation suppression in the event of air pollution deterioration, emergency warning issuance and evacuation guidance in the event of a disaster, and switching to a backup communication path and allocation of a priority communication band in the event of a communication device failure, respectively, based on the analysis result by the generative AI, and dynamically maintains the safety, efficiency, sustainability, and disaster response capability of the entire city.

What is claimed is:

1. A system comprising:
circuitry configured to:
receive, via a communication interface coupled to a packet-switched network, streaming sensor data from a plurality of sensor devices in an urban environment comprising environmental condition values, network traffic metrics, and device state parameters, and store the received data in a storage device;
apply a generative neural network model to the streaming sensor data and a long-term memory data structure storing historical sensor data patterns to compute a comprehensive state score vector comprising a plurality of infrastructure condition indicators;
apply a resource allocation optimization model to the state score vector to generate updated frequency allocation parameters, power distribution parameters, and coverage area configuration parameters, and transmit the updated parameters to communication infrastructure control endpoints via the communication interface;
update a digital twin model of the urban environment by mapping the streaming sensor data to virtual state variables of infrastructure component nodes, apply a graph neural network to the digital twin model to execute message passing operations, and generate an infrastructure optimization control command; and
transmit the infrastructure optimization control command and a monitoring dashboard data record to terminal devices via the communication interface.

2. The system according to claim 1, wherein the circuitry is configured to receive streaming sensor data from sensor devices via a gigabit-class broadband network connection, apply packet header analysis to execute traffic priority control, construct a distributed hash table indexing sensor device network addresses to enable sub-millisecond device lookup, and cache received sensor data in an in-memory database for real-time query access.

3. The system according to claim 2, wherein the circuitry is configured to implement an end-to-end encrypted communication protocol for all data transmissions between sensor devices and the system, assign a unique network address to each sensor device, and route data packets to appropriate processing modules based on sensor device type identifiers in packet header fields.

4. The system according to claim 1, wherein the circuitry is configured to apply the generative neural network model to the streaming sensor data and the long-term memory data structure by incorporating historical weather data patterns, historical communication traffic patterns, and device failure history records as long-term context, and generate the state score vector by processing the combined current and historical context.

5. The system according to claim 1, wherein the circuitry is configured to apply the resource allocation optimization model to the state score vector by solving a constrained optimization problem that maximizes aggregate communication coverage while satisfying power budget constraint parameters and interference avoidance constraint parameters, and generate the updated frequency allocation and power distribution parameters from the optimal solution.

6. The system according to claim 5, wherein the circuitry is configured to apply a prediction model to the state score vector to generate a predicted future state score vector over a configurable forecast horizon, incorporate the predicted future state vector as a planning constraint in the resource allocation optimization model, and generate forward-looking frequency and power allocation parameters.

7. The system according to claim 1, wherein the circuitry is configured to update the digital twin model in real time by applying a sensor data fusion algorithm to streaming sensor values from heterogeneous sensor modalities, maintaining a consistent virtual state representation for each infrastructure component node, and applying the graph neural network to propagate state updates across all connected component nodes.

8. The system according to claim 7, wherein the circuitry is configured to detect an infrastructure failure event by identifying sensor nodes with missing or anomalous data streams, update the corresponding infrastructure component node state variables in the digital twin model to reflect the failure condition, and apply the generative neural network model to generate a recovery action sequence.

9. The system according to claim 8, wherein the circuitry is configured to apply an autonomous recovery algorithm to the failure event by selecting alternative communication routing configurations from a pre-computed routing table, transmitting reconfiguration commands to unaffected communication infrastructure control endpoints via the communication interface, and updating frequency allocation and coverage area parameters to compensate for the failed component.

10. The system according to claim 1, wherein the circuitry is configured to apply a scenario simulation model by modifying specified infrastructure component node state variables in the digital twin model according to hypothetical failure or load condition parameters, re-applying the generative neural network model to generate predicted state vectors, and transmit comparative scenario outcome data to terminal devices.

11. The system according to claim 1, wherein the circuitry is configured to apply a natural language processing model to query text received from a terminal device, retrieve relevant digital twin model state data and historical optimization records from a vector database by cosine similarity search, and generate a natural language explanation of the current infrastructure optimization state.

12. The system according to claim 1, wherein the circuitry is configured to monitor key infrastructure performance indicators derived from the state score vector against configurable alert threshold parameters, generate an alert data record when a performance indicator crosses an alert threshold, and transmit the alert data record with a recommended response action sequence to terminal devices associated with operational management user identifiers.

13. The system according to claim 1, wherein the circuitry is configured to update the generative neural network model and the resource allocation optimization model by generating training pairs from historical state score vectors and corresponding validated infrastructure outcome records, and fine-tune the models to improve optimization accuracy.

14. The system according to claim 1, wherein the circuitry is configured to generate the monitoring dashboard data record from the digital twin model state comprising infrastructure component status visualizations, performance metric trend charts, and coverage area map overlays, and transmit the dashboard data record to terminal devices for display.

15. The system according to claim 1, wherein the circuitry is configured to distribute processing tasks across a plurality of computing nodes using a container orchestration platform, execute the generative neural network model inference on graphics processing unit accelerators, and dynamically scale computing resources based on incoming sensor data stream volume.

16. The system according to claim 1, wherein the circuitry is configured to apply a self-learning update procedure to the long-term memory data structure by extracting new pattern records from recently received streaming sensor data, adding the new pattern records to the long-term memory data structure, and recomputing memory index vectors to maintain retrieval accuracy.

17. The system according to claim 1, wherein the sensor devices are distributed across an urban geographic area, the infrastructure component nodes in the digital twin model represent communication infrastructure components and environmental monitoring devices, and the frequency allocation parameters and power distribution parameters are transmitted to communication infrastructure control endpoints for deployment.

18. A system comprising:
circuitry configured to:
receive, via a communication interface coupled to a packet-switched network, streaming sensor data from sensor devices in an urban environment via an encrypted communication protocol with distributed hash table device addressing;
apply a generative neural network model to the streaming sensor data and a long-term memory data structure to generate a state score vector, and apply a resource allocation optimization model to generate frequency allocation and power distribution parameters;
update a digital twin model by applying sensor data fusion and a graph neural network, detect failure events and apply autonomous recovery algorithms;
apply scenario simulations to hypothetical conditions in the digital twin model; and
transmit optimization parameters and dashboard data to terminal devices via the communication interface.

19. The system according to claim 18, wherein the circuitry is configured to apply a prediction model to forecast future state vectors over a planning horizon for incorporation as planning constraints, apply a natural language processing model to retrieve relevant digital twin state data by cosine similarity for query responses, and apply a self-learning update procedure to expand the long-term memory data structure with new sensor pattern records.

20. A method comprising:
receiving, via a communication interface coupled to a packet-switched network, streaming sensor data from sensor devices in an urban environment, and storing the data in a storage device;
applying a generative neural network model to the streaming sensor data and a long-term memory data structure to compute a state score vector;
applying a resource allocation optimization model to generate updated frequency allocation, power distribution, and coverage area configuration parameters, and transmitting the parameters to communication infrastructure control endpoints;
updating a digital twin model and applying a graph neural network to generate an infrastructure optimization control command; and
transmitting the infrastructure optimization control command and monitoring dashboard data to terminal devices via the communication interface.
